(19) United States
(12) Patent Application Publication
(10) Pub. No.: US 2026/0250443 A1
(43) Pub. Date: Aug. 27, 2026

(54) Resin Composition, Method For Manufacturing Electronic Apparatus, And Electronic Apparatus

(71) Applicant: Samsung Display Co., Ltd., Yongin-si (KR)

(72) Inventor: Keisuke Morita, Yokohama-shi (JP)

(73) Assignee: Samsung Display Co., Ltd., Yongin-si (KR)

(21) Appl. No.: 19/537,801

(22) Filed: Feb. 12, 2026

(30) Foreign Application Priority Data
Feb. 27, 2025 (JP) 2025-029934

(51) Int. Cl. C08F 220/18; C08F 220/20; C08L 33/10; C09J 7/22

(52) U.S. Cl. CPC C08F 220/1804; C08F 220/20; C08L 33/10; C09J 7/22

(57) ABSTRACT

A resin composition may include a (meth)acrylate copolymer derived from a radical polymerization reaction of a first (meth)acrylate monomer including a hindered phenol group and a second (meth)acrylate monomer including a hindered amine group. The resin composition may exhibit excellent processability when photocured in an atmosphere, and may exhibit excellent adhesive strength and excellent weather resistance after curing.

### CROSS-REFERENCE TO RELATED APPLICATIONS

This U.S. non-provisional patent application claims priority under 35 U.S.C. § 119 to Japanese Patent Application No. 2025-029934, filed on Feb. 27, 2025, the entire contents of which are hereby incorporated by reference.

### TECHNICAL FIELD

The present disclosure herein relates to a resin composition including a (meth)acrylate copolymer, a method for manufacturing an electronic apparatus, including providing the resin composition, and an electronic apparatus.

### BACKGROUND

Various types of electronic apparatuses used for multimedia devices such as television sets, mobile phones, tablet computers, navigation systems, and game consoles have been developed. Electronic apparatuses may include multiple components forming the electronic apparatuses, and may include display panels that generate images. Adhesive members are disposed between the components forming the electronic apparatuses. Resin compositions are provided to form the adhesive members, and the adhesive members included in the electronic apparatuses are required to stably bond the components of the electronic apparatuses and exhibit no degradation in display quality.

### SUMMARY

The present disclosure provides a resin composition that exhibits excellent processability during curing and excellent adhesive strength and excellent weather resistance after curing.

The present disclosure also provides a method for manufacturing an electronic apparatus that exhibits excellent processability.

The present disclosure also provides an electronic apparatus that exhibits excellent reliability.

An aspect of the present disclosure provides a resin composition including a (meth)acrylate copolymer derived from a radical polymerization reaction of a first (meth)acrylate monomer including a hindered phenol group and a second (meth)acrylate monomer including a hindered amine group.

In an aspect, the (meth)acrylate copolymer may be represented by Formula 1 below.

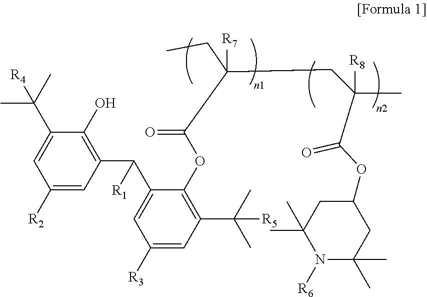

In Formula 1 above, R₁ may be a hydrogen atom or an alkyl group having 1 to 10 carbon atoms, R₂ to R₅ may each independently be an alkyl group having 1 to 10 carbon atoms, R₆ may be a hydrogen atom, an alkyl group having 1 to 10 carbon atoms, or an alkoxy group having 1 to 12 carbon atoms, R₇ and R₈ may each independently be a hydrogen atom or a methyl group, n1 may be an integer of 1 to 24, and n2 may be an integer of 12 to 200.

In an aspect, the first (meth)acrylate monomer may include a first moiety represented by Formula M-1 below, and the second (meth)acrylate monomer may include a second moiety represented by Formula M-2 below.

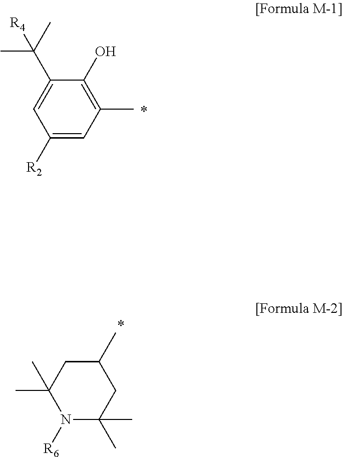

In Formula M-1 above, R₂ and R₄ may each independently be an alkyl group having 1 to 10 carbon atoms, and in Formula M-2 above, R₆ may be a hydrogen atom, an alkyl group having 1 to 10 carbon atoms, or an alkoxy group having 1 to 12 carbon atoms.

In an aspect, with respect to 100 parts by weight of a total weight of the (meth)acrylate monomers provided in the radical polymerization reaction, the first (meth)acrylate monomer may be provided in an amount of about 0.01 parts by weight to about 20 parts by weight.

In an aspect, in the radical polymerization reaction, a third (meth)acrylate monomer that does not include the hindered phenol group and the hindered amine group may be further provided.

In an aspect, the third (meth)acrylate monomer may include a functional group that absorbs ultraviolet rays.

In an aspect, the third (meth)acrylate monomer may include at least one of 2-[2-hydroxy-5-[2-(methacryloyloxy)ethyl]phenyl]-2H-benzotriazole or methyl methacrylate (MMA).

In an aspect, the resin composition may further include at least one monofunctional (meth)acrylate monomer and at least one photoradical polymerization initiator, and the monofunctional (meth)acrylate monomer may include at least one of 4-hydroxybutyl acrylate (4-HBA), 2-ethylhexyl acrylate (2-EHA), or tetrahydrofurfuryl acrylate (THFA).

In an aspect, the resin composition may have a 180° peel strength of about 1500 gf/25 mm or greater against at least one of a glass substrate or a polymer substrate at a temperature of about 25° C. after atmospheric curing.

In an aspect of the present disclosure, a method for manufacturing an electronic apparatus includes preparing a display panel, providing a window on the display panel, and providing an adhesive member on the display panel or the window before the providing of the window, wherein the providing of the adhesive member includes providing a resin composition including a (meth)acrylate copolymer on the display panel or the window, and irradiating the provided resin composition with light in an atmosphere to form the adhesive member, and the (meth)acrylate copolymer is derived from a radical polymerization reaction of a first (meth)acrylate monomer including a hindered phenol group and a second (meth)acrylate monomer including a hindered amine group.

In an aspect, the (meth)acrylate copolymer may be represented by Formula 1 below.

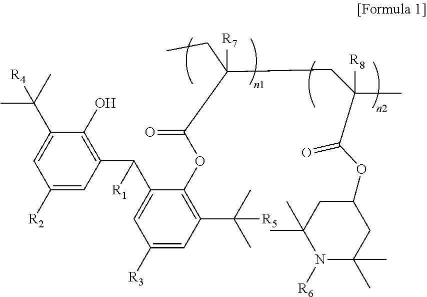

In Formula 1 above, R₁ may be a hydrogen atom or an alkyl group having 1 to 10 carbon atoms, R₂ to R₅ may each independently be an alkyl group having 1 to 10 carbon atoms, R₆ may be a hydrogen atom, an alkyl group having 1 to 10 carbon atoms, or an alkoxy group having 1 to 12 carbon atoms, R₇ and R₈ may each independently be a hydrogen atom or a methyl group, n1 may be an integer of 1 to 24, and n2 may be an integer of 12 to 200.

In an aspect, the first (meth)acrylate monomer may include a first moiety represented by Formula M-1 below, and the second (meth)acrylate monomer may include a second moiety represented by Formula M-2 below.

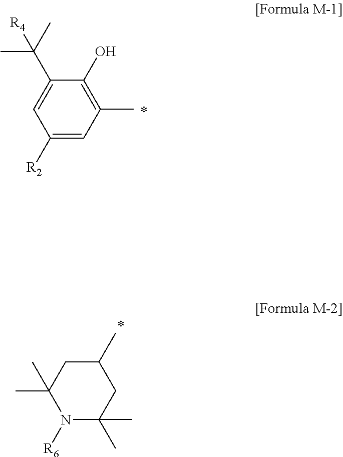

In Formula M-1 above, R₂ and R₄ may each independently be an alkyl group having 1 to 10 carbon atoms, and R₆ may be a hydrogen atom, an alkyl group having 1 to 10 carbon atoms, or an alkoxy group having 1 to 12 carbon atoms.

In an aspect, with respect to 100 parts by weight of a total weight of the (meth)acrylate monomers provided in the radical polymerization reaction, the first (meth)acrylate monomer may be provided in an amount of about 0.01 parts by weight to about 20 parts by weight.

In an aspect, in the radical polymerization reaction, a third (meth)acrylate monomer that does not include the hindered phenol group and the hindered amine group may be further provided.

In an aspect, the resin composition may further include at least one monofunctional (meth)acrylate monomer and at least one photoradical polymerization initiator, and

In an aspect, the resin composition may be provided through inkjet printing or dispensing.

In an aspect of the present disclosure, an electronic apparatus includes a display panel, a window disposed on the display panel, and an adhesive member including a polymer derived from a resin composition and disposed between the display panel and the window, wherein the resin composition includes a (meth)acrylate copolymer derived from a radical polymerization reaction of a first (meth)acrylate monomer including a hindered phenol group and a second (meth)acrylate monomer including a hindered amine group.

In an aspect, the adhesive member may have a 180° peel strength of about 1500 gf/25 mm or greater against at least one of a glass substrate or a polymer substrate at a temperature of about 25° C.

In an aspect, the electronic apparatus may further include a light control layer disposed between the adhesive member and the window, and an optical adhesive layer disposed between the light control layer and the window, wherein the optical adhesive layer may include a polymer derived from the resin composition.

In an aspect, the electronic apparatus may further include an input sensing portion disposed between the display panel and the window, wherein the adhesive member may be disposed between the display panel and the input sensing portion or between the input sensing portion and the window.

### BRIEF DESCRIPTION OF THE FIGURES

The accompanying drawings are included to provide a further understanding of the present disclosure, and are incorporated in and constitute a part of this specification. The drawings illustrate aspects of the present disclosure and, together with the description, serve to explain principles of the present disclosure. In the drawings:

FIG. 1 is a perspective view showing an electronic apparatus according to an aspect;

FIG. 2 is a block diagram of an electronic apparatus according to an aspect;

FIG. 3 is a schematic view showing an electronic apparatus according to various aspects;

FIG. 4 is an exploded perspective view showing an electronic apparatus according to an aspect;

FIG. 5 is a cross-sectional view showing a portion corresponding to line I-I′ of FIG. 1;

FIG. 6 is a cross-sectional view showing a portion of an electronic apparatus according to an aspect;

FIG. 7A is a flowchart showing a method for manufacturing an electronic apparatus according to an aspect;

FIG. 7B is a flowchart showing a method for manufacturing an electronic apparatus according to an aspect;

FIG. 8A is a view schematically showing a step of a process for manufacturing an electronic apparatus according to an aspect;

FIG. 8B is a view schematically showing a step of a process for manufacturing an electronic apparatus according to an aspect;

FIG. 8C is a view schematically showing a step of a process for manufacturing an electronic apparatus according to an aspect;

FIG. 9A is a view schematically showing a step of a process for manufacturing an electronic apparatus according to an aspect;

FIG. 9B is a view schematically showing a step of a process for manufacturing an electronic apparatus according to an aspect;

FIG. 9C is a view schematically showing a step of a process for manufacturing an electronic apparatus according to an aspect;

FIG. 10A is a view schematically showing a step of a process for manufacturing an electronic apparatus according to an aspect;

FIG. 10B is a view schematically showing a step of a process for manufacturing an electronic apparatus according to an aspect;

FIG. 10C is a view schematically showing a step of a process for manufacturing an electronic apparatus according to an aspect;

FIG. 10D is a view schematically showing a step of a process for manufacturing an electronic apparatus according to an aspect;

FIG. 11 is a cross-sectional view showing an electronic apparatus according to an aspect;

FIG. 12 is a cross-sectional view showing an electronic apparatus according to an aspect; and

FIG. 13 is a view showing the inside of a vehicle in which an electronic apparatus according to an aspect is disposed.

### DETAILED DESCRIPTION

The present disclosure may be modified in many alternate forms, and thus specific aspects will be exemplified in the drawings and described in detail. It should be understood, however, that it is not intended to limit the present disclosure to the particular forms disclosed, but rather, is intended to cover all modifications, equivalents, and alternatives falling within the spirit and scope of the present disclosure.

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

Like reference numerals or symbols refer to like elements throughout. In the drawings, the thickness, ratio, and size of the elements are exaggerated for effectively describing the technical contents. The term “and/or” includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be termed a second element, component, region, layer or section without departing from the scope of the present disclosure. Similarly, a second element, component, region, layer or section could be termed a first element, component, region, layer or section. The singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Herein, an alkyl group may be linear or branched. The number of carbon atoms in the alkyl group is 1 to 60, 1 to 50, 1 to 30, 1 to 20, 1 to 10, or 1 to 6. Examples of the alkyl group may include a methyl group, an ethyl group, an n-propyl group, an isopropyl group, an n-butyl group, a s-butyl group, a t-butyl group, an i-butyl group, a 2-ethylbutyl group, a 3,3-a dimethylbutyl group, an n-pentyl group, an i-pentyl group, a neopentyl group, a t-pentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, an n-nonyl group, an n-decyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-icosyl group, a 2-ethylicosyl group, a 2-butylicosyl group, a 2-hexylicosyl group, a 2-octylicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, an n-triacontyl group, or the like, but are not limited thereto.

Herein, an alkoxy group may indicate one that an oxygen atom is bonded to the alkyl group as defined above. The alkoxy group may be linear, branched, or cyclic. The number of carbon atoms in the alkoxy group is not particularly limited, but may be, for example, 1 to 30, 1 to 20, or 1 to 10. Examples of the oxy group include methoxy, ethoxy, n-propoxy, isopropoxy, butoxy, pentyloxy, hexyloxy, octyloxy, nonyloxy, decyloxy, or the like, but are not limited thereto.

Herein, “ - - - *” indicates a site to be connected.

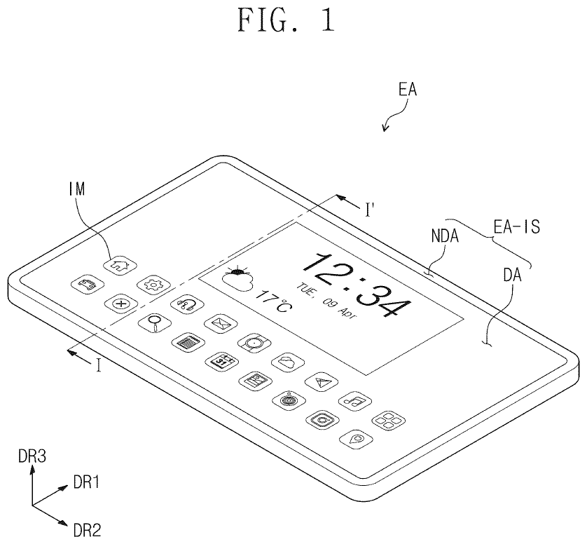

Hereinafter, aspects of the present disclosure will be described with reference to the accompanying drawings. FIG. 1 is a perspective view showing an electronic apparatus according to an aspect.

An electronic apparatus EA according to an aspect shown in FIG. 1 may be a device activated according to electrical signals. For example, the electronic apparatus EA may be personal computers, laptop computers, personal digital terminals, game consoles, portable electronic devices, television sets, monitors, outdoor billboards, car navigation systems, or wearable devices, but aspects of the present disclosure are not limited thereto. In FIG. 1, a portable electronic apparatus is presented as an example of the electronic apparatus EA.

The electronic apparatus EA may provide an image IM to users through a display surface EA-IS. The display surface EA-IS may be parallel to a plane defined by a first directional axis DR1 and a second directional axis DR2. The electronic apparatus EA may display an image IM toward a third directional axis DR3. The image IM may include still images and/or dynamic images. FIG. 1 shows an electronic apparatus EA provided with a flat display surface EA-IS, but aspects of the present disclosure are not limited thereto. For example, the electronic apparatus EA may include a curved display surface or a three-dimensional display surface. The three-dimensional display surface may include a plurality of display regions indicating different directions.

Directions indicated by the first to third directional axes DR1, DR2, and DR3 as described herein are relative concepts, and may thus be changed to other directions. In addition, the directions indicated by the first to third directional axes DR1, DR2, and DR3 may be described as first to third directions, and the same reference signs may be used.

Herein, the first directional axis DR1 and the second directional axis DR2 may be perpendicular to each other, and the third directional axis DR3 may be a normal direction to a plane defined by the first direction axis DR1 and the second directional axis DR2. A thickness direction of the electronic apparatus EA may be parallel to the third directional axis DR3. A thickness direction of the electronic apparatus EA may use the same reference numerals as third directional axis DR3. A front surface (or upper surface) and a rear surface (or lower surface) may oppose each other, and a normal direction of each of the front surface (or upper surface) and the rear surface (or lower surface) may be parallel to the third directional axis DR3. The front surface (or upper surface) indicates a surface adjacent to the display surface EA-IS, and the rear surface (or lower surface) indicates a surface spaced from the display surface EA-IS. The upper surface indicates a direction towards the display surface EA-IS, and the lower surface indicates a direction away from the display surface EA-IS.

Herein, a cross-section indicates a surface parallel to the thickness direction DR3. A plane indicates the surface perpendicular to the thickness direction DR3 and parallel to the plane defined by the first directional axis DR1 and the second directional axis DR2.

Herein, the wording, “one component and another component overlapping each other” indicates that the two components overlap one a plane. In addition, the overlapping of one component with another component is not limited to a case of having the same area size and same shape, and includes a case of having different area size and/or different shape.

The electronic apparatus EA may sense external inputs applied from the outside. The external inputs may include various forms of inputs provided from the outside the electronic apparatus EA. For example, the external inputs may include external inputs applied when approaching the electronic apparatus EA or being adjacent by a prescribed distance (e.g., hovering), as well as through contact by a part of a body such as a user's hand. In addition, the external inputs may have various forms such as force, pressure, temperature, light, and the like.

The display surface EA-IS may include a display region DA and a non-display region NDA. The electronic apparatus EA may display the image IM through the display region DA.

The display region DA may be a region activated according to electrical signals. The display region DA may be a region displaying the image IM and sensing various forms of external inputs.

The display region DA may include a plane defined by the first directional axis DR1 and the second directional axis DR2. Although not shown, the display region DA may include a curved surface bent from one side of the plane defined by the first directional axis DR1 and the second directional axis DR2. For example, the display region DA may further include at least two curved surfaces, for example, four curved surfaces each bent from four sides of the plane defined by the first directional axis DR1 and the second directional axis DR2.

The electronic apparatus EA according to an aspect may be flexible. The term “flexible” indicates a property of being bendable, and may include all from a structure being completely foldable to a structure being bendable up to several nanometers. For example, the electronic apparatus EA may support MR-DC. Unlike what is described above, the electronic apparatus EA may be a foldable device.

The non-display region NDA may have a prescribed color. The non-display region NDA may be a region adjacent to the display region DA. The non-display region NDA may surround the display region DA. Accordingly, the shape of the display region DA may be defined substantially by the non-display region NDA. However, FIG. 1 merely illustrates an example, and the non-display region NDA may be disposed adjacent to only one side of the display region DA, or may not be provided. The display region DA may be provided in various shapes and is not limited to any one aspect.

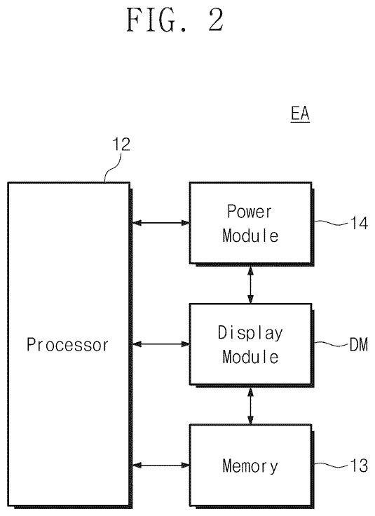

FIG. 2 is a block diagram of an electronic apparatus according to an aspect. Referring to FIG. 2, an electronic apparatus EA according to an aspect may include a display module DM, a processor 12, a memory 13, and a power module 14. Herein, the electronic apparatus EA may be a display device or may include a display device. The display device may include the display module DM.

The processor 12 may include at least one of a central processing unit (CPU), an application processor AP, a graphic processing unit (GPU), a communication processor (CP), an image signal processor (ISP), or a controller. The power module 14 may include a power supply module such as a power adapter or a battery device, and a power conversion module that converts power supplied by the power supply module to generate power required for the operation of the electronic apparatus EA.

The memory 13 may store data information required for the operation of the processor 12 or the display module DM. When the processor 12 executes an application stored in the memory 13, image data signals and/or input control signals are transmitted to the display module DM, and the display module DM may process the received signal and output image information through a display screen.

At least one of the components of the electronic apparatus EA may be included in the display module DM according to an aspect. In addition, among the components of the electronic apparatus EA, some of the individual modules functionally included in one module may be included in the display device, and others may be separately provided from the display device. For example, the display device may include a display module DM, and the processor 12, the memory 13, and the power module 14 may be provided in the form of other devices within the electronic apparatus EA, rather than the display device.

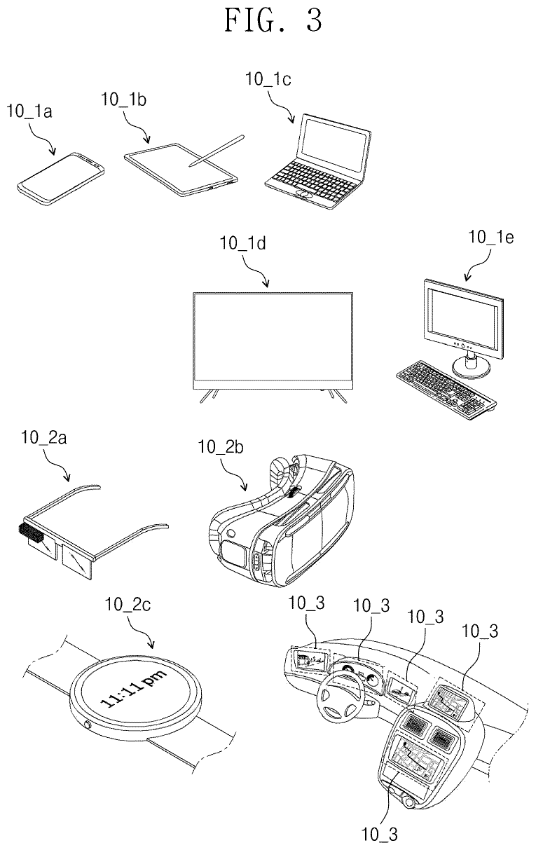

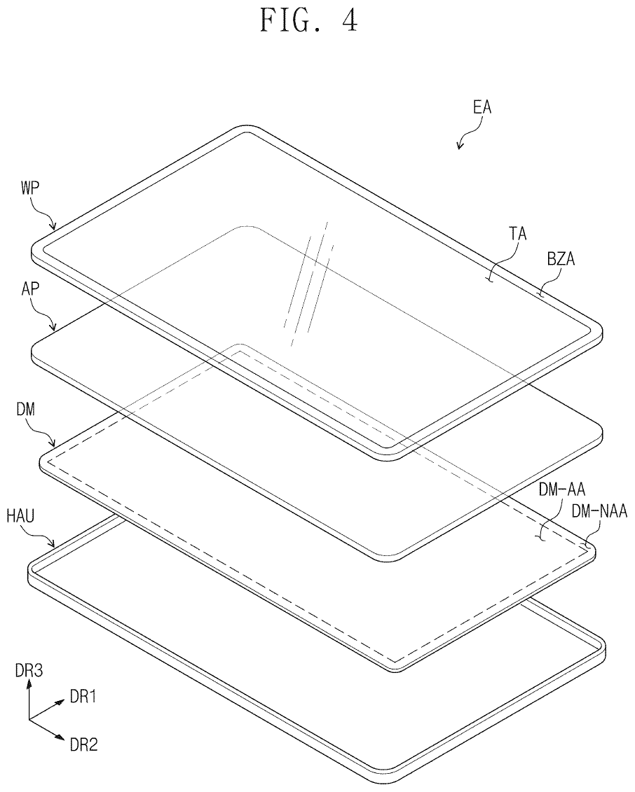

FIG. 3 is a schematic view showing an electronic apparatus according to various aspects. Referring to FIG. 3, an electronic apparatus including the display module DM (FIG. 4) may include an electronic apparatus for displaying images, such as a smart phone 10_1a, a tablet PC 10_1b, a laptop computer 10_1c, a TV 10_1d, or a desk monitor 10_1e, a wearable electronic apparatus including a display device such as a smart glasses 10_2a, a head mounted display 10_2b, or a smart watch 10_2c, or an in-vehicle electronic apparatus 10_3 including a display module such as a center information display (CID) or a room mirror display disposed on an instrument panel, a center fascia, or a dashboard of a vehicle.

FIG. 4 is an exploded perspective view showing an electronic apparatus according to an aspect. Referring to FIG. 4, the electronic apparatus EA may include a display module DM, a window WP disposed on the display module DM, and an adhesive member AP disposed between the display module DM and the window WP. In addition, the electronic apparatus EA may further include a housing HAU.

The housing HAU may include a material having a relatively greater rigidity. For example, the housing HAU may include frames and/or plates formed of glass, plastic, or metal. The frames and/or plates may be provided in plurality. The housing HAU may provide a prescribed place for accommodation. The display module DM may be accommodated in the accommodation place to be protected from external shocks.

The display module DM may be activated according to electrical signals and may provide the image IM (FIG. 1). The display module DM may be activated to display the image IM (FIG. 1) on the display region DA (FIG. 1) of the electronic apparatus EA. In the display module DM, an active region DM-AA and a peripheral region DM-NAA may be defined.

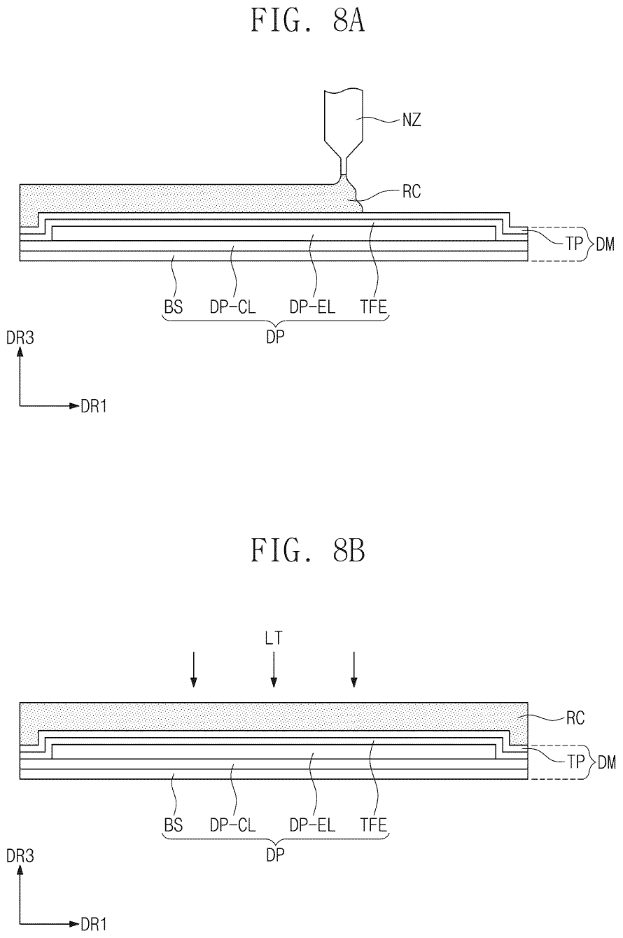

The active region DM-AA may be a region activated according to electrical signals. In the active region DM-AA, a pixel (not shown) may be disposed. The pixel may include a transistor TR and a light emitting element ED (FIG. 8). The peripheral region DM-NAA may be a region adjacent to at least one side of the active region DM-AA. A circuit, a line, or the like for driving the active region DM-AA may be disposed in the peripheral region DM-NAA.

The display module DM and the window WP may be bonded through the adhesive member AP. In an aspect, the adhesive member AP may include a polymer derived from a resin composition RC (FIGS. 8A, 9A, and 10A). The adhesive member AP may be formed by photocuring the resin composition RC (FIGS. 8A, 9A, and 10A). A (meth)acrylate copolymer according to an aspect may be derived from a radical polymerization reaction of a first (meth)acrylate monomer including a hindered phenol group and a second (meth)acrylate monomer including a hindered amine group. The adhesive member AP may be formed from the resin composition RC (FIGS. 8A, 9A, and 10A) including the (meth)acrylate copolymer according to an aspect, and may thus exhibit excellent adhesive strength and excellent weather resistance. In an aspect, the electronic apparatus EA including the adhesive member AP may exhibit excellent reliability and excellent display quality.

The window WP may be disposed on the adhesive member AP. The window WM may cover an entire outer portion of the electronic apparatus EA. The window WP may include a transmission region TA and a bezel region BZA. A front surface of the window WP including the transmission region TA and the bezel region BZA may serve as a front surface of the electronic apparatus EA. The transmission region TA may correspond to the display region DA of the electronic apparatus EA shown in FIG. 1, and the bezel region BZA may correspond to the non-display region NDA of the electronic apparatus EA shown in FIG. 1.

The transmission region TA may be an optically transparent region. The bezel region BZA may be a region having a relatively lower light transmittance than the transmission region TA. The bezel region BZA may have a prescribed color. The bezel region BZA may be adjacent to the transmission region TA and may surround the transmission region TA. The bezel region BZA may define a shape of the transmission region TA. However, aspects of the present disclosure are not limited to what is shown, and the bezel region BA may be disposed adjacent to only one side of the transmission region TA, and a portion thereof may not be provided.

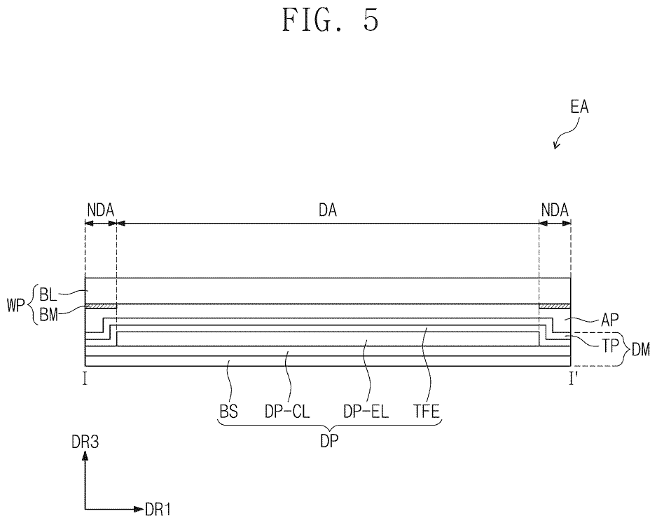

FIG. 5 is a cross-sectional view showing a portion corresponding to line I-I′ of FIG. 1. FIG. 5 may be a cross-sectional view schematically showing the electronic apparatus EA according to an aspect.

Referring to FIG. 5, the display module DM may include a display panel DP and an input sensing portion TP disposed on the display panel DP. The display panel DP may be configured to substantially generate images. The display panel DP may include a base substrate BS, a circuit layer DP-CL disposed on the base substrate BS, a display element layer DP-EL disposed on the circuit layer DP-CL, and an encapsulation layer TFE covering the display element layer DP-EL. The window WP may be disposed on the display panel DP. The adhesive member AP may be disposed between the display panel DP and the window WP.

The components of the display panel DP shown in FIG. 5 are an example and the components of the display panel DP are not limited thereto. For example, the display panel DP may include a liquid crystal display element, and in this case, the encapsulation layer TFE may not be provided.

The base substrate BS may provide a base surface on which the circuit layer DP-CL is disposed. The base substrate BS may be a flexible substrate that is bendable, foldable, rollable, or the like. The base substrate BS may be a glass substrate, a metal substrate, or a polymer substrate. However, aspects of the present disclosure are not limited thereto, and the base substrate BS may be an inorganic layer, an organic layer, or a composite material layer.

The circuit layer DP-CL may include an insulating layer, a semiconductor pattern, a conductive pattern, a signal line, and the like. For example, the circuit layer DP-CL may include a switching transistor and a driving transistor for driving a light emitting element ED (FIG. 8) of the display element layer DP-EL.

The display element layer DP-EL may include the light emitting element (FIG. 8) emitting light. For example, the light emitting element (FIG. 8) may include organic light emitting materials, inorganic light emitting materials, organic-inorganic light emitting materials, quantum dots, or quantum rods. For example, the light emitting element (FIG. 8) may include micro LEDs or nano LEDs.

The encapsulation layer TFE may be disposed on the display element layer DP-EL. The encapsulation layer TFE may serve to protect the light emitting element layer DP-EL from moisture, oxygen, and/or foreign substances such as dust particles. The encapsulation layer TFE may include at least one inorganic layer. For example, the encapsulation layer TFE may include an inorganic layer, an organic layer, and an inorganic layer, which are sequentially stacked.

The input sensing portion TP may be disposed between the window WP and the display panel DP. The adhesive member AP may be disposed between the input sensing portion TP and the window WP. For example, the input sensing portion TP may be directly disposed on the encapsulation layer TFE of the display panel DP.

Herein, when a component is directly disposed/provided/formed on another component, it indicates that a third component is not disposed/provided/formed between one component and another component. That is, when a component is ‘directly disposed/provided/formed’ on another component, it indicates that a component is in ‘contact’ with another component.

The input sensing portion TP may sense external inputs to convert the inputs into prescribed input signals, and provide the input signals to the display panel DP. For example, in the electronic apparatus EA according to an aspect, the input sensing portion TP may be a touch sensing portion sensing a touch. The input sensing portion TP may recognize a user's direct touch, a user's indirect touch, a direct touch of an object, or an indirect touch of an object.

The input sensing portion TP may sense at least any one of a location of a touch or strength (pressure) of a touch applied from the outside. In an aspect, the input sensing portion TP may have various structures or be formed of various materials, and is not limited to any one aspect. For example, the input sensing portion TP may sense external inputs using a capacitive method. The display panel DP may receive input signals from the input sensing portion TP and generate images corresponding to the input signals.

The window WP may include a base layer BL and a printing layer BM. Although not shown, the window WP may further include at least one functional layer (not shown) provided on the base layer BL. For example, the functional layer (not shown) may be a hard coating layer, an anti-fingerprint coating layer, and the like, but aspects of the present disclosure are not limited thereto.

The base layer BL may be a glass substrate. Alternatively, the base layer BL may be a plastic substrate. For example, the base layer BL may be formed of polyimide, polyacrylate, polymethylmethacrylate, polycarbonate, polyethylenenaphthalate, polyvinylidene chloride, polyvinylidene difluoride, polystyrene, ethylene vinylalcohol copolymer, or a combination thereof.

The printing layer BM may be disposed on one surface of the base layer BL. The printing layer BM may be provided on a lower surface of the base layer BL adjacent to the display module DM. The printing layer BM may be disposed on an edge region of the base layer BL. The printing layer BM may be an ink printing layer. In addition, the printing layer BM may be a layer formed by including pigment or dye. In the window WP, the bezel region BZA (FIG. 4) may be a portion in which the printing layer BM is provided.

The adhesive member AP may be disposed between the input sensing portion TP and the window WP. The adhesive member AP according to an aspect may have a 180° peel strength of at least about 1500 gf/25 mm against at least one of a glass substrate or a polymer substrate at a temperature of about 25° C. For example, the adhesive member AP may have a 180° peel strength of at least about 3000 gf/25 mm against at least one of a glass substrate or a polymer substrate at a temperature of about 25° C. The adhesive member AP formed from the resin composition RC (FIGS. 8A, 9A, and 10A) including the (meth)acrylate copolymer according to an aspect may exhibit a high 180° peel strength of 1500 gf/25 mm or greater. The adhesive member AP having a 180° peel strength of about 1500 gf/25 mm or greater against at least one of a glass substrate or a polymer substrate at a temperature of about 25° C. may exhibit excellent adhesive strength and may stably bond components (e.g., the display module DM, the window WP, or the like) constituting an electronic apparatus EA. Herein, the 180° peel strength indicates a value measured using a method of JIS (Japanese Industrial Standards) Z037.

The adhesive member AP according to an aspect may have a yellow index (YI) of about 0.5 or less after a weather resistance test. The usage environment of an electronic apparatus includes exposure to environments such as heat and light. The weather resistance test is performed to determine the resistance of an adhesive members to discoloration and fading upon exposure to environments such as heat and light for extended periods. The adhesive member AP having a yellow index of about 0.5 or less after a weather resistance test exhibits no or minimal discoloration or fading upon exposure to environments such as heat and light for extended periods. Therefore, the adhesive member AP having a yellow index of about 0.5 or less after a weather resistance test may exhibit excellent weather resistance.

An adhesive member having a yellow index of greater than about 0.5 after a weather resistance test have low resistance to discoloration and fading upon exposure to environments such as heat and light for extended periods, and exhibits discoloration and/or fading as exposure time to environments such as heat and light accumulates. The adhesive member exhibiting discoloration and/or fading degrades the display quality of images generated from a display module disposed below the adhesive member. The images generated from the display module passes through the adhesive member and is provided to users. The adhesive member AP according to an aspect has a yellow index of about 0.5 or less after a weather resistance test, and an electronic apparatus EA including the adhesive member AP may exhibit excellent reliability and excellent display quality.

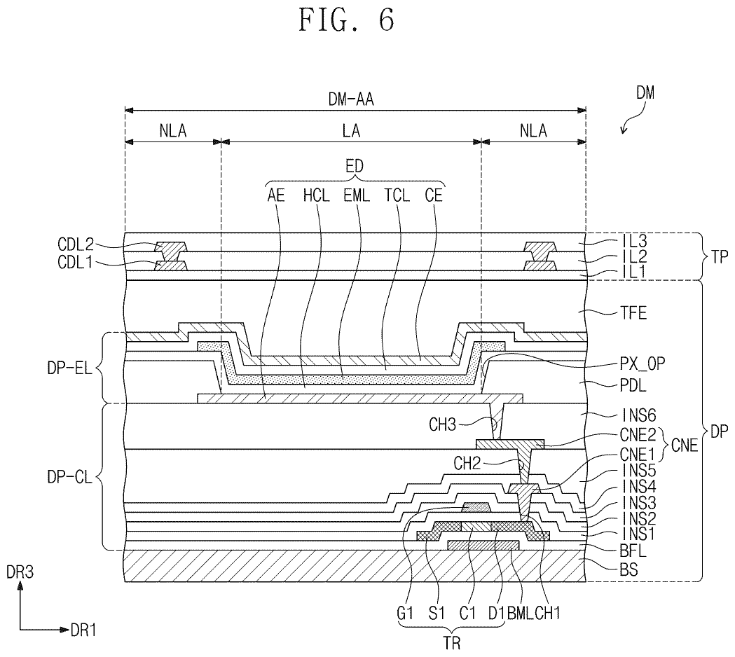

FIG. 6 is a cross-sectional view showing a display module DM according to an aspect; FIG. 6 may be a cross-sectional view showing an active region DM-AA of the display module DM. Components of the display module DM shown in FIG. 6 are presented as an example, and the aspects of the present disclosure are not limited thereto.

The base substrate BS may include a single layer or multiple layers. For example, the base substrate BS may include a first synthetic resin layer, a multi- or single-layered inorganic layer, and a second synthetic resin layer disposed on the multi- or single-layered inorganic layer. Each of the first synthetic resin layer and the second synthetic resin layer may include a polyimide-based resin. In addition, each of the first synthetic resin layer and the second synthetic resin layer may include at least one of an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, or a perylene-based resin. Herein, a “~based” resin may be considered as including a functional group of “~~”.

The display panel DP may include a transistor TR and a light emitting element ED. The transistor TR and the light emitting element ED may be disposed on the base substrate BS. Although one transistor TR is shown in FIG. 6, the display panel DP may include a plurality of transistors and at least one capacitor for driving the light emitting element ED.

The circuit layer DP-CL may be disposed on the base substrate BS. The circuit layer DP-CL may include a shielding electrode BML, a transistor TR, a connection electrode CNE, and a plurality of insulating layers BFL and INS1 to INS6. The plurality of insulating layers BFL and INS1 to INS6 may include a buffer layer BFL and first to sixth insulating layers INS1 to INS6. However, the stack structure of the circuit layer DP-CL shown in FIG. 6 is presented as an example, and the stack structure of the circuit layer DP-CL may change depending on components of the display panel DP and processes of the circuit layer DP-CL.

The shielding electrode BML may be disposed on the base substrate BS. The shielding electrode BML may overlap the transistor TR. The shielding electrode BML may protect the transistor TR by blocking light incident on the transistor TR from a lower portion of the display panel DP. The shielding electrode BML may include a conductive material. When a voltage is applied to the shielding electrode BML, threshold voltage of the transistor TR disposed on the shielding electrode BML may be maintained. However, aspects of the present disclosure are not limited thereto, and the shielding electrode BML may be a floating electrode. The shielding electrode BML may not be provided.

The buffer layer BFL may be disposed on the base substrate BS to cover the shielding electrode BML. The buffer layer BFL may include an inorganic layer. The buffer layer BFL may improve the bonding force between the base substrate BS and a semiconductor pattern or a conductive pattern disposed on the buffer layer BFL.

The transistor TR may include a source S1, a channel C1, a drain D1, and a gate G1. The source S1, the channel C1, and the drain D1 of the transistor TR may be formed from the semiconductor pattern. The semiconductor pattern of the transistor TR may include polysilicon, amorphous silicon, or metal oxide, and may be applied without limitation as long as it has semiconductor properties, and is not limited to any one.

The semiconductor pattern may include a plurality of regions divided according to the level of conductivity. In the semiconductor pattern, a region doped with a dopant or reduced with metal oxide may have high conductivity and may substantially serve as a source electrode and a drain electrode of the transistor TR. The region having high conductivity in the semiconductor pattern may correspond to the source S1 and the drain D1 of the transistor TR. In the semiconductor pattern, a region undoped, doped at a low concentration, or non-reduced with metal oxide, thereby having low conductivity, may correspond to the channel C1 (or active) of the transistor TR.

The first insulating layer INS1 may cover the semiconductor pattern of the transistor TR and be disposed on the buffer layer BFL. The gate G1 of the transistor TR may be disposed on the first insulating layer INS1. When viewed on a plane, the gate G1 may overlap the channel C1 of the transistor TR. The gate G1 may serve as a mask in the process of doping the semiconductor pattern of the transistor TR.

The second insulating layer INS2 may cover the gate G1 and be disposed on the first insulating layer INS1. The third insulating layer INS3 may be disposed on the second insulating layer INS2.

The connection electrode CNE may include a first connection electrode CNE1 and a second connection electrode CNE2 to electrically connect the transistor TR and the light emitting element ED. However, the components of the connection electrode CNE that electrically connect the transistor TR and the light emitting element ED is not limited thereto, and one of the first and second connection electrodes CNE1 and CNE2 may not be provided or an additional connection electrode may be further included.

The first connection electrode CNE1 may be disposed on the third insulating layer INS3. The first connection electrode CNE1 may be connected to the drain D1 through a first contact hole CH1 passing through the first to third insulating layers INS1 to INS3. The fourth insulating layer INS4 may cover the first connection electrode CNE1 and be disposed on the third insulating layer INS3. The fifth insulating layer INS5 may be disposed on the fourth insulating layer INS4.

The second connection electrode CNE2 may be disposed on the fifth insulating layer INS5. The second connection electrode CNE2 may be connected to the first connection electrode CNE1 through a second contact hole CH2 passing through the fourth and fifth insulating layers INS4 and INS5. The sixth insulating layer INS6 may cover the second connection electrode CNE2 and be disposed on the fifth insulating layer INS5.

The first to sixth insulating layers INS1 to INS6 may each include an inorganic layer or an organic layer. For example, the inorganic layer may include at least one of aluminum oxide, titanium oxide, silicon oxide, silicon oxynitride, zirconium oxide, or hafnium oxide. The organic layer may include at least any one of an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, or a perylene-based resin.

The display element layer DP-EL may include a pixel defining film PDL and a light emitting element ED. The light emitting element ED may include a first electrode AE, a hole control layer HCL, an emission layer EML, an electron control layer TCL, and a second electrode CE. The second electrode CE may be disposed on the first electrode AE. The emission layer EML may be disposed between the first electrode AE and the second electrode CE. The hole control layer HCL may be disposed between the first electrode AE and the emission layer EML. The electron control layer TCL may be disposed between the emission layer EML and the second electrode CE.

The first electrode AE may be disposed on the sixth insulating layer INS6. The first electrode AE may be connected to the second connection electrode CNE2 through a third contact hole CH3 passing through the sixth insulating layer INS6. The first electrode AE may be electrically connected to the drain D1 of the transistor TR through the first and second connection electrodes CNE1 and CNE2.

The first electrode AE may be formed of a metal material, a metal alloy, or a conductive compound. The first electrode AE may be an anode or a cathode. However, aspects of the present disclosure are not limited thereto. In addition, the first electrode AE may be a pixel electrode. The first electrode AE may be a transmissive electrode, a transflective electrode, or a reflective electrode. The first electrode AE may include at least one selected from Ag, Mg, Cu, Al, Pt, Pd, Au, Ni, Nd, Ir, Cr, Li, Ca, LiF, Mo, Ti, W, In, Sn, or Zn, two or more compounds selected therefrom, two or more mixtures selected therefrom, or an oxide thereof.

When the first electrode AE is a transmissive electrode, the first electrode AE may include a transparent metal oxide such as indium tin oxide (ITO), indium zinc oxide (IZO), zinc oxide (ZnO), or indium tin zinc oxide (ITZO). When the first electrode AE is a transflective electrode or a reflective electrode, the first electrode AE may include Ag, Mg, Cu, Al, Pt, Pd, Au, Ni, Nd, Ir, Cr, Li, Ca, LiF/Ca (a stack structure of LiF and Ca), LiF/Al (a stack structure of LiF and Al), Mo, Ti, W, a compound thereof, or a mixture thereof (e.g., a mixture of Ag and Mg). Alternatively, the first electrode AE may have a multilayer structure including a reflective film or a transflective film formed of the above-described materials, and a transparent conductive film formed of indium tin oxide (ITO), indium zinc oxide (IZO), zinc oxide (ZnO), indium tin zinc oxide (ITZO), or the like. For example, the first electrode AE may have a three-layer structure of ITO/Ag/ITO, but is not limited thereto. In addition, aspects of the present disclosure are not limited thereto, and the first electrode AE may include the above-described metal materials, a combination of two or more metal materials selected from the above-described metal materials, or oxides of the above-described metal materials.

The pixel defining film PDL may be disposed on the sixth insulating layer INS6. A light emitting opening PX_OP exposing a portion of the first electrode AE may be defined in the pixel defining film PDL. A portion of the first electrode AE exposed by the light emitting opening PX_OP may be defined as a light emitting region LA.

The active region DM-AA of the display module DM may include the light emitting region LA and a light blocking region NLA. A region in which the pixel defining film PDL is disposed may correspond to the light blocking region NLA. The light blocking region NLA may surround the light emitting region LA in the active region DM-AA.

The hole control layer HCL may be disposed on the first electrode AE and the pixel defining film PDL. The hole control layer HCL may be provided as a common layer overlapping the light emitting region LA and the light blocking region NLA. Unlike what is shown, the hole control layer HCL may be disposed within a region corresponding to the light emitting opening PX_OP. The hole control layer HCL may include at least one of a hole transport layer, a hole injection layer, or an electron blocking layer. The hole control layer HCL may include known hole injection materials and/or known hole transport materials.

The emission layer EML may be disposed on the hole control layer HCL. The emission layer EML may be disposed in a region corresponding to the light emitting opening PX_OP. Alternatively, the emission layer EML may be provided as a common layer. The emission layer EML may include an organic light emitting material and/or an inorganic light emitting material. For example, the emission layer EML may emit color light of any one of red, green, and blue. For example, the emission layer EML may emit blue light.

The electron control layer TCL may be disposed on the emission layer EML. The electron control layer TCL may be provided as a common layer overlapping the light emitting region LA and the light blocking region NLA. Unlike what is shown, the electron control layer TCL may be disposed within a region corresponding to the light emitting opening PX_OP. The electron control layer TCL may include at least one of an electron transport layer, an electron injection layer, or a hole blocking layer. The electron control layer TCL may include known electron injection materials and/or known electron transport materials.

The second electrode CE may be disposed on the electron control layer TCL. The second electrode CE may be provided as a common layer overlapping the light emitting region LA and the light blocking region NLA. The second electrode CE may be a common electrode. The second electrode CE may be a cathode or an anode but aspects of the present disclosure are not limited thereto. For example, when the first electrode AE is an anode, the second electrode CE may be a cathode, and when the first electrode AE is a cathode, the second electrode CE may be an anode.

The second electrode CE may be a transmissive electrode, a transflective electrode, or a reflective electrode. When the second electrode CE is a transmissive electrode, the second electrode CE may be formed of a transparent metal oxide, for example, indium tin oxide (ITO), indium zinc oxide (IZO), zinc oxide (ZnO), indium tin zinc oxide (ITZO), or the like.

When the second electrode CE is a transflective electrode or a reflective electrode, the second electrode CE may include Ag, Mg, Cu, Al, Pt, Pd, Au, Ni, Nd, Ir, Cr, Li, Ca, LiF/Ca, LiF/Al, Mo, Ti, Yb, W, a compound thereof, or a mixture thereof (e.g., AgMg, AgYb, or MgYb). Alternatively, the second electrode CE may have a multi-layer structure including a reflective film or a transflective film formed of the above-described materials, and a transparent conductive film formed of indium tin oxide (ITO), indium zinc oxide (IZO), zinc oxide (ZnO), indium tin zinc oxide (ITZO), or the like. For example, the second electrode CE may include the above-described metal materials, a combination of two or more metal materials selected from the above-described metal materials, or oxides of the above-described metal materials.

The encapsulation layer TFE may be disposed on the second electrode CE and may thus cover the light emitting element ED. The encapsulation layer TFE may include a plurality of thin films. For example, the encapsulation layer TFE may include inorganic layers disposed on the second electrode CE and an organic layer disposed between the inorganic layers. The inorganic film may protect the light emitting element ED from moisture/oxygen, and the organic film may protect the light emitting element ED from foreign substances such as dust particles.

The input sensing portion TP may include a first sensing insulating layer IL1, a second sensing insulating layer IL2, and a third sensing insulating layer IL3. The input sensing portion TP may include at least one conductive layer disposed on the sensing insulating layers. The input sensing portion TP may include a first conductive layer CDL1 and a second conductive layer CDL2.

The first sensing insulating layer IL1 may be disposed on the encapsulation layer TFE. The first sensing insulating layer IL1 may include at least one inorganic insulating layer. The first sensing insulating layer IL1 may be in contact with the encapsulation layer TFE. Alternatively, the first sensing insulating layer IL1 may not be provided, and in this case, the first conductive layer CDL1 may contact the encapsulation layer TFE.

The first conductive layer CDL1 may be disposed on the first sensing insulating layer IL1. The first conductive layer CDL1 may include a plurality of first conductive patterns. The plurality of first conductive patterns may be disposed on the first sensing insulating layer IL1. The second sensing insulating layer IL2 may be disposed on the first sensing insulating layer IL1 to cover at least a portion of the first conductive layer CDL1.

The second conductive layer CDL2 may be disposed on the second sensing insulating layer IL2. The second conductive layer CDL2 may include a plurality of second conductive patterns. The plurality of second conductive patterns may be disposed on the second sensing insulating layer IL2. The plurality of second conductive patterns may each be connected to the plurality of first conductive patterns through a contact hole formed in the second sensing insulating layer IL2.

The plurality of first conductive patterns of the first conductive layer CDL1 and the plurality of second conductive patterns of the second conductive layer CDL2 may each be disposed to correspond to the light blocking region NLA. The plurality of first conductive patterns of the first conductive layer CDL1 and the plurality of second conductive patterns of the second conductive layer CDL2 may each correspond to a mesh pattern.

The third sensing insulating layer IL3 may be disposed on the second sensing insulating layer IL2 and may cover the second conductive layer CDL2. The second sensing insulating layer IL2 and the third sensing insulating layer IL3 may each include an inorganic insulating layer or an organic insulating layer.

The first conductive layer CDL1 and the second conductive layer CDL2 each may have a single-layered structure or may have a multi-layered structure stacked along the third direction DR3. The single-layered conductive layers CDL1 and CDL2 may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), or indium zinc tin oxide (IZTO). In addition, the transparent conductive layer may include a conductive polymer such as PEDOT, metal nanowire, graphene, and the like.

The multi-layered conductive layers CDL1 and CDL2 may include metal layers. For example, the metal layers may have a three-layer structure of titanium (Ti)/aluminum (Al)/titanium (Ti). The multi-layered conductive layers CDL1 and CDL2 may include at least one metal layer and at least one transparent conductive layer.

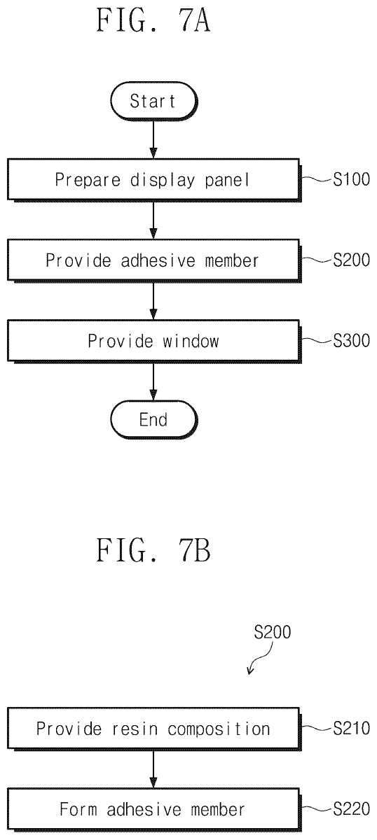

The electronic apparatus according to an aspect may be manufactured using a method for manufacturing an electronic apparatus according to an aspect. FIGS. 7A and 7B are flowcharts showing a method for manufacturing an electronic apparatus according to an aspect. FIGS. 8A to 10D are views schematically showing sequential steps of methods for manufacturing an electronic apparatus according to an aspect. To provide descriptions with reference to FIGS. 7A to 10D, descriptions that overlap the descriptions provided with reference to FIGS. 1 to 6 will not be provided, and differences will be mainly described.

Referring to FIG. 7A, the method for manufacturing an electronic apparatus according to an aspect may include preparing a display panel (S100), providing an adhesive member (S200), and providing a window (S300). Prior to the providing of the window (S300), the providing of the adhesive member AP, FIG. 5 on the display panel DP (FIG. 5) or the window WP (FIG. 5) (S200) may be performed. Referring to FIG. 7B, the providing the adhesive member (S200) may include providing a resin composition (S210) and forming an adhesive member (S220).

FIGS. 8A to 8C may show sequential steps of a method for manufacturing an electronic apparatus according to an aspect, including providing a resin composition RC on a display panel DP. Referring to FIG. 8A, the resin composition RC may be provided on a first surface of a display module DM including the display panel DP. The first surface of the display module DM may be an upper surface of the display module DM. The resin composition RC may be provided on the first surface of the display module DM through a nozzle NZ. FIG. 8A shows that the resin composition RC is provided through the nozzle NZ, but the device for providing the resin composition RC is not limited thereto.

The resin composition RC according to an aspect may be provided through inkjet printing or dispensing. A liquid resin composition RC may be provided in a uniform amount and/or at a uniform rate.

The resin composition according to an aspect may include a (meth)acrylate copolymer, and the (meth)acrylate copolymer may be derived from a radical polymerization reaction of a first (meth)acrylate monomer including a hindered phenol group and a second (meth)acrylate monomer including a hindered amine group. Herein, the (meth)acryloyl group indicates an acryloyl group or a methacryloyl group, and the (meth)acrylate indicates acrylate or methacrylate.

For example, the (meth)acrylate copolymer may be formed through a radical thermal polymerization reaction. In an aspect, a thermal polymerization initiator may be provided in the radical polymerization reaction for forming the (meth)acrylate copolymer.

The (meth)acrylate copolymer formed from the radical polymerization reaction of a the first (meth)acrylate monomer including a hindered phenol group and the second (meth)acrylate monomer including a hindered amine group may include a hindered phenol group and a hindered amine group. The hindered phenol group may be a reducing functional group, and the hindered amine group may be a photostable functional group. The hindered phenol group and the hindered amine group included in the (meth)acrylate copolymer may trap oxygen radicals that cause curing inhibition at an outermost surface.

The (meth)acrylate copolymer including both a hindered phenol group and a hindered amine group may exhibit a synergistic effect of the hindered phenol group and the hindered amine group. According to an aspect, the (meth)acrylate copolymer, upon photocuring of the resin composition RC, may segregate on the outermost surface, thereby securing adhesiveness through a certain cohesive force and inhibiting (or preventing) environmental degradation caused by heat/light at an interface with air through the synergistic effect. The outermost surface indicates an outermost surface of a resin composition applied for photocuring and may be a surface closest to the atmosphere. Accordingly, the resin composition according to an aspect may have a 180° peel strength of at least about 1500 gf/25 mm against at least one of a glass substrate or a polymer substrate at a temperature of about 25° C. after atmospheric photocuring. In addition, the resin composition RC according to an aspect, after photocuring, may have a yellow index of about 0.5 or less after a weather resistance test.

When forming an adhesive member by irradiating the resin composition with light in an atmosphere, oxygen in the atmosphere inhibits surface curing. Radicals generated through cleavage by light from a photopolymerization initiator and radicals at an end of the (meth)acrylate group that grow through polymerization reaction are consumed by oxygen in the atmosphere at an interface between the atmosphere and the surface (i.e., the surface of the applied resin composition) to form peroxide radicals, thereby inhibiting high molecular weight polymer formation by the polymerization reaction. During the polymerization reaction, an adhesive member, which is a cured product of a resin composition, is formed through the high molecular weight polymer formation of provided reactants. In contrast, the resin composition RC according to an aspect includes a (meth)acrylate copolymer including a hindered amine group and a hindered phenol group, and may thus exhibit excellent processability upon photocuring in the atmosphere.

The (meth)acrylate copolymer according to an aspect may be represented by Formula 1 below. The first (meth)acrylate monomer may include a first moiety represented by Formula M-1 below, and the second (meth)acrylate monomer may include a second moiety represented by Formula M-2 below. The first moiety may be a hindered phenol group. The second moiety may be a hindered amine group.

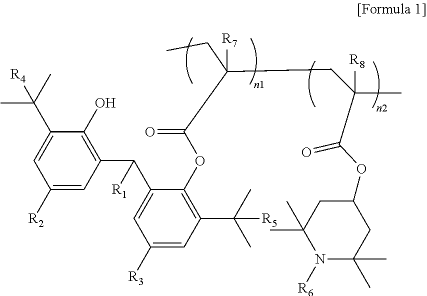

In Formula 1, R₁ may be a hydrogen atom or an alkyl group having 1 to 10 carbon atoms. R₂ to R₅ may each independently be an alkyl group having 1 to 10 carbon atoms. R₆ may be a hydrogen atom, an alkyl group having 1 to 10 carbon atoms, or an alkoxy group having 1 to 12 carbon atoms. R₇ and R₈ may each independently be a hydrogen atom or a methyl group. For example, n1 may be an integer of 1 to 24, and n2 may be an integer of 12 to 200. For example, R₁ may be a hydrogen atom or a methyl group. R₂ and R₃ may each independently be a methyl group or an i-pentyl group. R₄ and R₃ may each independently be a methyl group or an ethyl group.

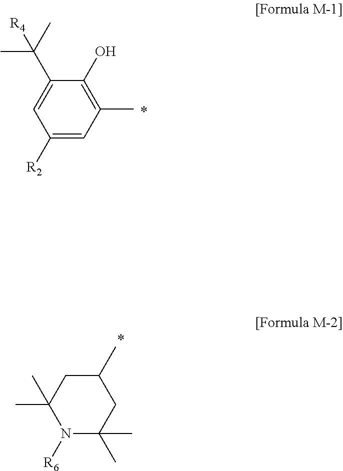

In Formula M-1, R₂ and R₄ may each independently be an alkyl group having 1 to 10 carbon atoms. In Formula M-2, R₆ may be a hydrogen atom, an alkyl group having 1 to 10 carbon atoms, or an alkoxy group having 1 to 12 carbon atoms. The first moiety represented by Formula M-1 and the second moiety represented by Formula M-2 may each be included in Formula 1.

The (meth)acrylate copolymer according to an aspect may have a weight average molecular weight of about 3,000 to about 50,000. The (meth)acrylate copolymers having a weight average molecular weight of about 3,000 to about 50,000 may exhibit a sufficient degree of polymerization and after the completion of the polymerization reaction, may show characteristics that facilitate the removal of impurities through methods such as solution precipitation. In addition, the (meth)acrylate copolymers having a weight average molecular weight of about 3,000 to about 50,000 may exhibit excellent solubility, providing a resin composition with excellent uniformity.

In contrast, a (meth)acrylate copolymer having a weight average molecular weight of less than about 3,000 exhibits an insufficient degree of polymerization and after the completion of the polymerization reaction, exhibits characteristics where the removal of impurities through methods such as solution precipitation is not easy. A (meth)acrylate copolymer having a weight average molecular weight of greater than about 50,000 exhibits extremely low solubility, hardly providing a uniform resin composition.

In the radical polymerization reaction for forming the (meth)acrylate copolymer according to an aspect, in addition to the first and second (meth)acrylate monomers, a third (meth)acrylate monomer may be further provided. The third (meth)acrylate monomer may be a monomer that does not include a hindered phenol group and a hindered amine group. For example, the third (meth)acrylate monomer may include at least one of 2-[2-hydroxy-5-[2-(methacryloyloxy)ethyl]phenyl]-2H-benzotriazole or methyl methacrylate (MMA).

The third (meth)acrylate monomer may include a functional group that absorbs ultraviolet rays (hereinafter referred to as a ‘UV-absorbing functional group’). A resin composition RC including the (meth)acrylate copolymer derived from the third (meth)acrylate monomer including a UV-absorbing functional group may exhibit excellent weather resistance after curing. For example, the third (meth)acrylate monomer including an UV-absorbing functional group may include at least one of a benzotriazole-based monomer, a benzophenone-based monomer, a salicylic acid-based monomer, a salicylate-based monomer, a cyanoacrylate-based monomer, a cinnamate-based monomer, an oxanilide-based monomer, a polystyrene-based monomer, a polyferrocenylsilane-based monomer, a methine-based monomer, an azomethine-based monomer, a triazine-based monomer, a para-aminobenzoic acid-based monomer, a cinnamic acid-based monomer, or a urocanic acid-based monomer. Specifically, the third (meth)acrylate monomer including a UV-absorbing functional group may include at least one of a benzotriazole-based monomer, a benzophenone-based monomer, or a triazine-based monomer.

With respect to 100 parts by weight of a total weight of the (meth)acrylate monomers provided in the radical polymerization reaction for forming a (meth)acrylate copolymer, the first (meth)acrylate monomer may be provided in an amount of about 0.01 parts by weight to about 20 parts by weight. For example, when only the first and second (meth)acrylate monomers are provided in the radical polymerization reaction for forming a (meth)acrylate copolymer, the first (meth)acrylate monomer may be provided in an amount of about 0.01 parts by weight to about 20 parts by weight, with respect to 100 parts by weight of a total weight of the first (meth)acrylate monomer and the second (meth)acrylate monomer. Alternatively, when the first to third (meth)acrylate monomers are provided in the radical polymerization reaction for forming a (meth)acrylate copolymer, the first (meth)acrylate monomer may be provided in an amount of about 0.01 parts by weight to about 20 parts by weight, with respect to 100 parts by weight of a total weight of the first (meth)acrylate monomer, the second (meth)acrylate monomer, and the third (meth)acrylate monomer.

When the first (meth)acrylate monomer is provided in an amount of less than about 0.01 parts by weight with respect to 100 parts by weight of a total weight of the (meth)acrylate monomers provided in the radical polymerization reaction for forming a (meth)acrylate copolymer, the synergistic effect described above with the second (meth)acrylate including a hindered amine group is not achieved. Since the amount of the first (meth)acrylate monomer including a hindered phenol group is insufficient, the synergistic effect with the second (meth)acrylate including a hindered amine group is not achieved.

When the first (meth)acrylate monomer is provided in an amount of greater than about 20 parts by weight with respect to 100 parts by weight of a total weight of the (meth)acrylate monomers provided in the radical polymerization reaction for forming a (meth)acrylate copolymer, the polymerization reaction is excessively inhibited, thereby reducing the degree of polymerization of the (meth)acrylate copolymer. The first (meth)acrylate monomer may serve as a radical trap, and when provided in an excess amount of greater than about 20 parts by weight, the polymerization reaction is inhibited.

Due to the radical trapping by the monomer including a hindered phenol group, forming a (meth)acrylate copolymer by providing only the monomer including a hindered phenol group alone is virtually unfeasible. In addition, the (meth)acrylate copolymer formed when the monomer including a hindered phenol group is provided in an amount of greater than about 20 parts by weight, when included in a resin composition, exhibits excessive light absorption, thereby inhibiting a photocuring reaction in which an adhesive member is formed from the resin composition.

In the method for manufacturing the electronic apparatus EA (FIG. 5) according to an aspect, the first (meth)acrylate monomer may be provided in an amount of about 0.01 to about 20 parts by weight with respect to 100 parts by weight of a total weight of the (meth)acrylate monomers provided in the radical polymerization reaction for forming a (meth)acrylate copolymer. Accordingly, the synergistic effect described above and the (meth)acrylate copolymer according to an aspect may be obtained.

The resin composition RC according to an aspect may further include at least one monofunctional (meth)acrylate monomer and at least one photoradical polymerization initiator. For example, the monofunctional (meth)acrylate monomer may include at least one of 4-hydroxybutyl acrylate (4-HBA), 2-ethylhexyl acrylate (2-EHA), or tetrahydrofurfuryl acrylate (THFA). The photoradical polymerization initiator may include phenyl bis(2,4,6-trimethylbenzoyl)-phosphine oxide.

When the resin composition RC includes a plurality of photoradical polymerization initiators, different photoradical polymerization initiators may be activated by ultraviolet rays having different central wavelengths. For example, the photoradical polymerization initiator may include at least one of 2,2-dimethoxy-1,2-diphenylethan-1-one, 1-hydroxy cyclohexyl-phenylketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one.

In addition, the photoradical polymerization initiator may include at least one of 2-methyl-1[4-(methylthio)phenyl]-2-morpholinopropan-1-one, 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, phenyl bis(2,4,6-trimethylbenzoyl)phosphine oxide, [1-(4-phenylsulfanylbenzoyl)heptylideneamino]benzoate, [1-[9-ethyl-6-(2-methylbenzoyl)carbazol-3-yl]ethylideneamino]acetate), or bis(2,4-cyclopentadienyl)bis[2,6-difluoro-3-(1-pyrryl)phenyl] titanium (IV).

Referring to FIGS. 8A and 8B, the resin composition RC may be directly applied onto a first surface of the display module DM, and the resin composition RC applied to a certain thickness may be irradiated with light LT. For example, the light LT may be ultraviolet rays. After irradiated with the light LT, the resin composition RC may be cured to form the adhesive member AP shown in FIG. 8C. After the adhesive member AP is formed, a window WP may be attached onto one surface of the adhesive member AP.

The resin composition RC may be irradiated with the light LT in the atmosphere. The resin composition RC according to an aspect may include a (meth)acrylate according to an aspect, thereby preventing (or minimizing) inhibition due to oxygen in the atmosphere and exhibiting excellent processability.

Although FIG. 8B shows that the provided resin composition RC is directly irradiated with the light LT, a carrier film (not shown) may be disposed on the resin composition RC unlike what is shown. The carrier film may transmit ultraviolet rays.

FIGS. 8A to 8C show that the adhesive member AP is formed by curing the resin composition RC once (i.e., curing by providing light once), but aspects of the present disclosure are not limited thereto. For example, the adhesive member AP may be formed by curing the resin composition RC at least two times.

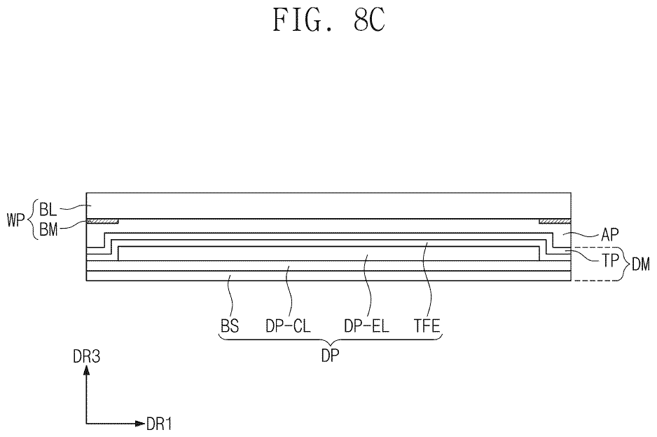

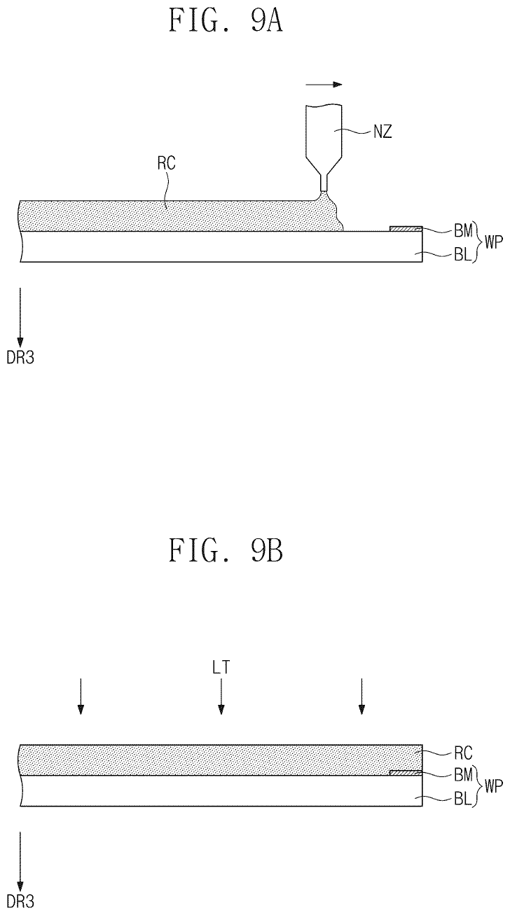

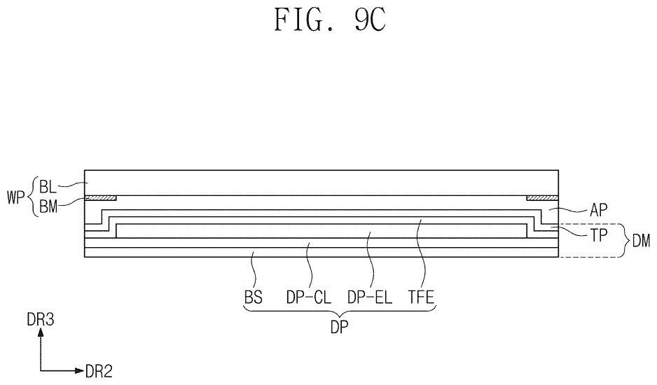

FIGS. 9A to 9C are views showing steps of providing an adhesive member according to another aspect of the present disclosure. To provide descriptions with reference to FIGS. 9A to 9C, descriptions that overlap the descriptions provided with reference to FIGS. 1 to 8C will not be provided, and differences will be mainly described.

The manufacturing method shown in FIGS. 9A to 9C may represent a method for manufacturing an electronic apparatus according to an aspect, including providing a resin composition RC on a window WP. Referring to FIG. 9A, the resin composition RC may be provided on a second surface of the window WP through a nozzle NZ. The resin composition RC may be directly provided on the second surface of the window WP. The second surface of the window WP may be a lower surface of the window WP.

Referring to FIGS. 9B and 9C, the light LT may be applied onto the resin composition RC applied to a prescribed thickness, and the resin composition RC may be cured by the light LT to form an adhesive member AP. Subsequently, a display module DM may be attached onto one surface of the adhesive member AP.

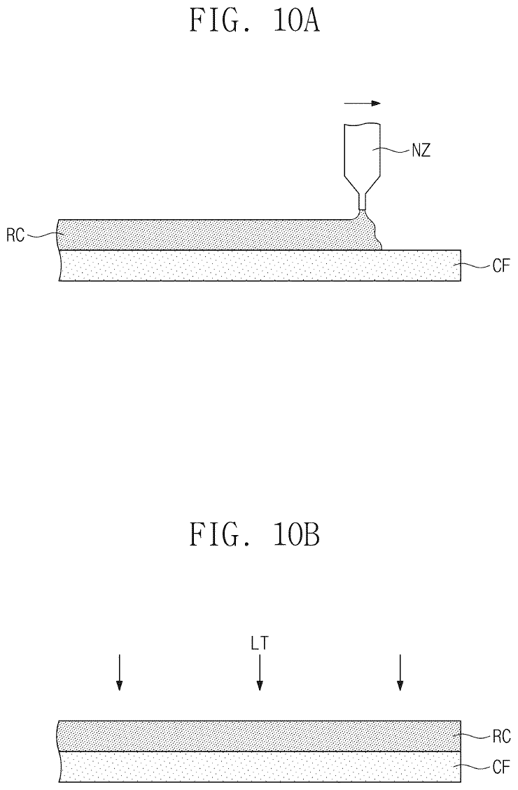

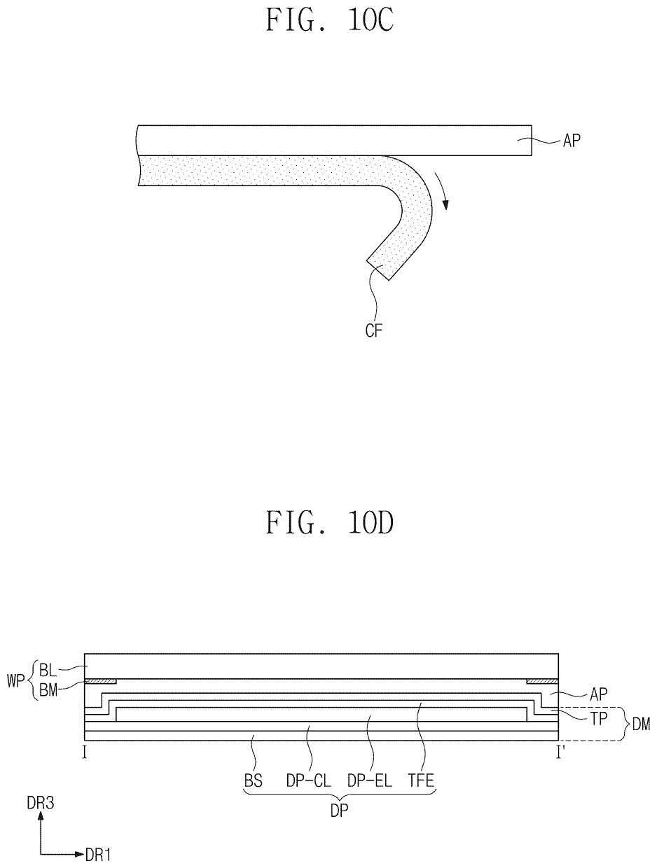

FIGS. 10A to 10D are views showing steps of providing an adhesive member according to another aspect of the present disclosure. To provide descriptions with reference to FIGS. 10A to 10D, descriptions that overlap the descriptions provided with reference to FIGS. 1 to 9C will not be provided, and differences will be mainly described.

Referring to FIG. 10A, the resin composition RC may be provided onto a substrate CF through the nozzle NZ. For example, the substrate CF on which the resin composition RC is provided may include polyethylene terephthalate (PET). The substrate CF is a temporary substrate used to form the adhesive member AP (FIG. 10D) from the resin composition RC, and may be used without limitation as long as it is easily detached after the resin composition RC is cured. One surface of the substrate CF on which the resin composition RC is provided may be subjected to release treatment.

Referring to FIGS. 10B and 10C, the resin composition RC applied to a prescribed thickness onto the substrate CF may be irradiated with the light LT to form the adhesive member AP. The resin composition RC may be cured by the light LT to form the adhesive member AP. Referring to FIGS. 10C and 10D, the formed adhesive member AP may be detached from the substrate CF and provided onto the first surface of the display module DM or the second surface of the window WP. One surface of the adhesive member AP may be laminated onto the first surface of the display module DM or the second surface of the window WP, and a third surface of the window WP or a fourth surface of the display module DM, which is not attached onto the remaining surface of the adhesive member AP, may be attached. In the display module DM, the first surface and the fourth surface may be spaced apart in the thickness direction DR3. In the window WP, the second surface and the third surface may be spaced apart in the thickness direction DR3.

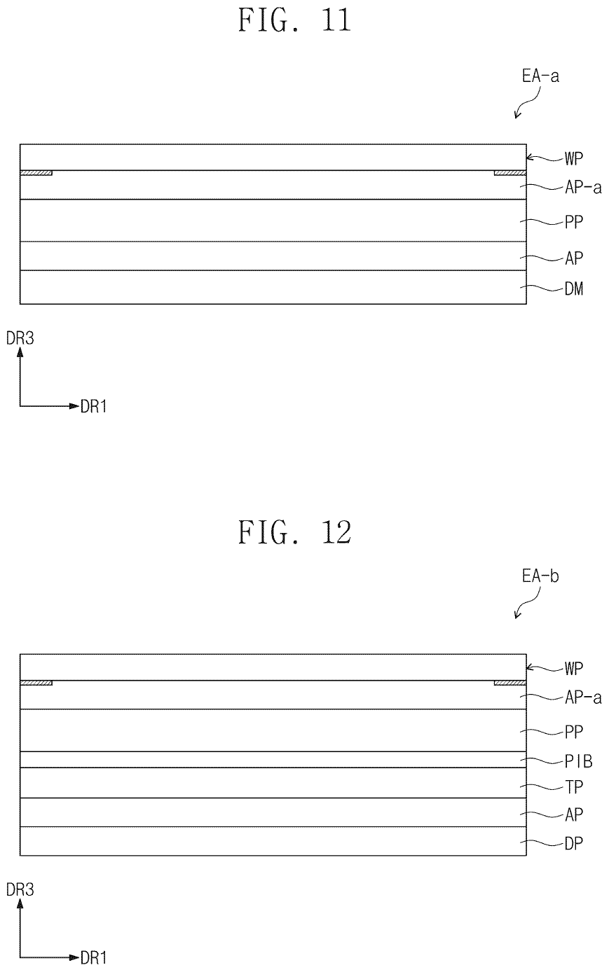

FIGS. 11 and 12 are cross-sectional views showing an electronic apparatus according to another aspect of the present disclosure. To provide descriptions with reference to FIGS. 11 and 12, descriptions that overlap with the descriptions provided with reference to FIGS. 1 to 10C will not be provided, and differences will be mainly described.

Compared with the electronic apparatus EA shown in FIGS. 4 and 5, an electronic apparatus EA-a shown in FIG. 11 may further include a light control layer PP and an optical adhesive layer AP-a. The electronic apparatus EA-a according to an aspect may further include a light control layer PP disposed between the adhesive member AP and the window WP, and an optical adhesive layer AP-a disposed between the light control layer PP and the window WP. For example, the light control layer PP may include a color filter layer or a polarizing plate.

The optical adhesive layer AP-a may include a polymer derived from the resin composition RC (FIGS. 8A, 9A, and 10A) according to an aspect. The optical adhesive layer AP-a including the polymer derived from the resin composition RC (FIGS. 8A, 9A, and 10A) may have a 180° peel strength of about 1500 gf/25 mm or greater at a temperature of about 25° C. against at least one of a glass substrate or a polymer substrate. The optical adhesive layer AP-a including the polymer derived from the resin composition RC (FIGS. 8A, 9A, and 10A) may have a yellow index of about 0.5 or less after a weather resistance test. Accordingly, the electronic apparatus EA-a including the optical adhesive layer AP-a may exhibit excellent reliability and excellent display quality.

Compared with the electronic apparatus EA shown in FIGS. 4 and 5, an electronic apparatus EA-b according to an aspect shown in FIG. 12 may further include a light control layer PP, an optical adhesive layer AP-a, and an interlayer adhesive layer PIB. As the electronic apparatus EA-a according to an aspect shown in FIG. 11, the electronic apparatus EA-b according to an aspect shown in FIG. 12 may further include the light control layer PP disposed between the adhesive member AP and the window WP, and the optical adhesive layer AP-a disposed between the light control layer PP and the window WP.

In the electronic apparatus EA-b according to an aspect, the adhesive member AP may be provided between the display panel DP and the input sensing portion TP. That is, the input sensing portion TP may not be directly disposed on the display panel DP, and the display panel DP and the input sensing portion TP may be bonded through the adhesive member AP. For example, the adhesive member AP may be disposed between the encapsulation layer TFE (FIG. 5) of the display panel DP and the input sensing portion TP.

The interlayer adhesive layer PIB may be provided below the light control layer PP. The interlayer adhesive layer PIB may be disposed between the input sensing portion TP and the light control layer PP and may be formed of an adhesive material having excellent moisture permeation prevention properties. For example, the interlayer adhesive layer PIB may be formed including polyisobutylene. The interlayer adhesive layer PIB may be disposed on the input sensing portion TP to prevent corrosion of sensing electrodes of the input sensing portion TP. The electronic apparatus EA-b according to an aspect includes the optical adhesive layer AP-a and the adhesive member AP formed from the resin composition RC (FIGS. 8A, 9A, and 10A) according to an aspect, and may thus exhibit excellent reliability and excellent display quality.

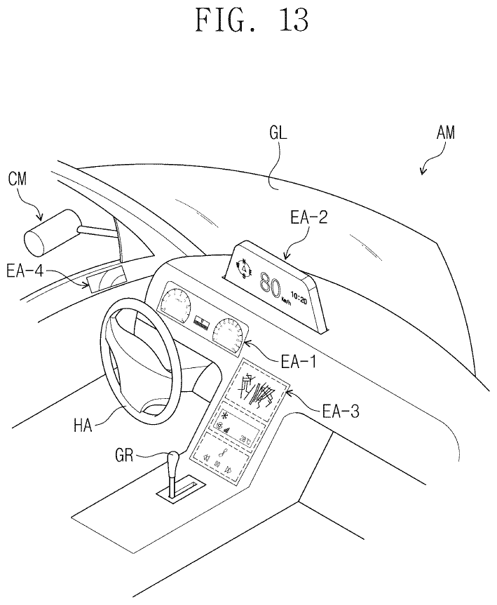

FIG. 13 is a view showing a vehicle AM in which first to fourth electronic apparatuses EA-1, EA-2, EA-3, and EA-4 are disposed. At least one of the first to fourth electronic apparatuses EA-1, EA-2, EA-3, and EA-4 may have the same components as any one of the electronic apparatuses EA, EA-a, and EA-b according to an aspect described with reference to FIGS. 1 to 5, 11, and 12. At least one of the first to fourth electronic apparatuses EA-1, EA-2, EA-3, and EA-4 may include the adhesive member AP according to an aspect described with reference to FIGS. 1 to 5, 11, and 12.

FIG. 13 shows a car as the vehicle AM, but this is presented as an example, and the first to fourth electronic apparatuses EA-1, EA-2, EA-3, and EA-4 may be disposed on other means of transportation, such as bicycles, motorcycles, trains, ships, and airplanes. In addition, at least one of the first to fourth electronic apparatuses EA-1, EA-2, EA-3, and EA-4 including the same components as any one of the electronic apparatuses EA, EA-a, and EA-b (FIGS. 1 to 5, 11, and 12) according to an aspect may be adopted for other electronic apparatuses without departing from the concepts of the present disclosure.

At least one of the first to fourth electronic apparatuses EA-1, EA-2, EA-3, and EA-4 may include the adhesive member AP (FIG. 5) according to an aspect. The adhesive member AP (FIG. 5) according to an aspect is formed from the resin composition RC (FIGS. 8A, 9A, and 10A) according to an aspect, and may thus exhibit excellent adhesive strength and excellent weather resistance.

Referring to FIG. 13, the vehicle AM may include a wheel HA and a gear GR for operating the vehicle AM, and have a front window GL disposed to face a driver.

The first electronic apparatus EA-1 may be disposed in a first region overlapping the wheel HA. For example, the first electronic apparatus EA-1 may be a digital cluster displaying first information of the vehicle AM. The first information may include a first scale indicating driving speed of the vehicle AM, a second scale indicating engine revolutions (i.e., revolutions per minute (RPM)), and an image indicating fuel gauge, and the like. The first scale and the second scale may be displayed as digital images.

The second electronic apparatus EA-2 may be disposed in a second region facing a driver seat and overlapping the front window GL. The driver seat may be a seat in which the wheel HA is disposed. For example, the second electronic apparatus EA-2 may be a head up display HUD displaying second information of the vehicle AM. The second electronic apparatus EA-2 may be optically transparent. The second information includes digital numbers indicating driving speed of the vehicle AM and may further include information such as current time. Unlike what is shown, the second information of the second electronic apparatus EA-2 may be projected and displayed on the front window GL.

The third electronic apparatus EA-3 may be disposed in a third region adjacent to the gear GR. For example, the third electronic apparatus EA-3 may be a center information display CID for a vehicle, which is disposed between a driver seat and a front passenger seat and displays third information. The passenger seat may be a seat spaced apart from the driver seat with the gear GR therebetween. The third information may include information about road conditions (e.g., navigation information), music or radio play, dynamic video (or image) play, temperature inside the vehicle AM, and the like.

The fourth electronic apparatus EA-4 may be disposed in a fourth region spaced apart from the wheel HA and the gear GR and adjacent to a side of the vehicle AM. For example, the fourth electronic apparatus EA-4 may be a digital side mirror displaying fourth information. The fourth electronic apparatus EA-4 may display images of conditions outside the vehicle AM, which are taken by a camera module CM disposed outside the vehicle AM. The fourth information may include images of conditions outside the vehicle AM.

The first to fourth information described above are presented as an example, and the first to fourth electronic apparatuses EA-1, EA-2, EA-3, and EA-4 may further display information about inside or outside a vehicle. The first to fourth information may include different information. However, aspects of the present disclosure are not limited thereto, and some of the first to fourth information may include the same information.

Hereinafter, with reference to Examples and Comparative Examples, the resin composition according to an aspect of the present disclosure and the adhesive member formed from the resin composition will be specifically described. In addition, Examples below are shown only for the understanding technical features of the present disclosure, and the scope of the present disclosure is not limited thereto.

### EXAMPLES

### 1. Preparation of (Meth)Acrylate Copolymer

(Meth)acrylate copolymers MA-1 to MA-6 provided in resin compositions of Examples and Comparative Examples were synthesized through the following methods of Synthesis Examples 1 to 6, respectively. The (meth)acrylate copolymers MA-1 to MA-4 are (meth)acrylate copolymers of Examples. The (meth)acrylate copolymers MA-5 and MA-6 are copolymers of Comparative Examples. SUMILIZER GM (RN: 61167-58-6), SUMILIZER GS (RN: 123968-25-2), and LA-82 (RN: 68548-08-3) shown below are materials used in the synthesis of (meth)acrylate copolymers MA-1 to MA-5. SUMILIZER GM and SUMILIZER GS include hindered phenol groups. LA-82 includes a hindered amine group.

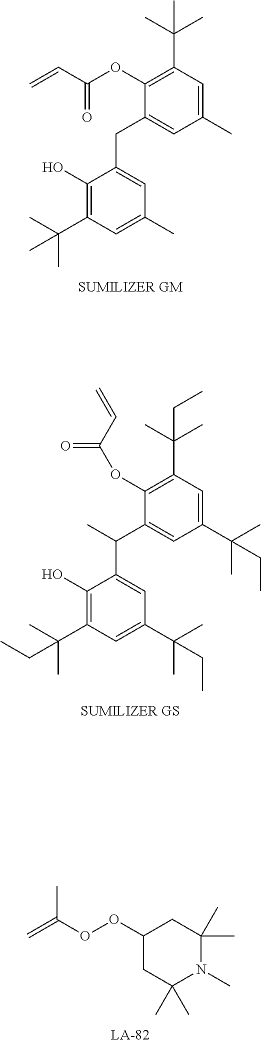

In the synthesis of (meth)acrylate copolymer MA-1, SUMILIZER GM was used as a first (meth)acrylate monomer including a hindered phenol group, and LA-82 was used as a second (meth)acrylate monomer including a hindered amine group. In the synthesis of (meth)acrylate copolymer MA-2, SUMILIZER GS was used as a first (meth)acrylate monomer including a hindered phenol group, and LA-82 was used as a second (meth)acrylate monomer including a hindered amine group.

In the synthesis of (meth)acrylate copolymer MA-3, SUMILIZER GM was used as a first (meth)acrylate monomer including a hindered phenol group, LA-82 was used as a second (meth)acrylate monomer including a hindered amine group, and RUVA-93 was used as a third (meth)acrylate monomer. In the synthesis of (meth)acrylate copolymer MA-4, SUMILIZER GM was used as a first (meth)acrylate monomer including a hindered phenol group, LA-82 was used as a second (meth)acrylate monomer including a hindered amine group, and RUVA-93 and MMA were used as a third (meth)acrylate monomer.

In the synthesis of (meth)acrylate copolymer MA-5, a first (meth)acrylate monomer including a hindered phenol group was not used, but LA-82 was used as a second (meth)acrylate monomer including a hindered amine group, and RUVA-93 was used as a third (meth)acrylate monomer. In the synthesis of (meth)acrylate copolymer MA-6, 2-isocyanatoethyl methacrylate and n-butylacrylate were used as monomers.

### Synthesis Example 1: Synthesis of (Meth)Acrylate Copolymer MA-1

To a 100 ml round bottom flask equipped with a condenser, a dropping funnel, a nitrogen inlet tube, and a magnetic stirrer, 30 ml of n-butyl acetate (manufactured by KISHIDA CHEMICAL Co., Ltd.) was added, and the mixture was stirred at room temperature for 30 minutes under nitrogen bubbling to deoxygenate the solvent. The resulting product was heated in an oil bath up to an internal temperature of about 90° C. Then, 2.10 g of 2-tert-butyl-6-(3-tert-butyl-2-hydroxy-5-methylbenzyl)-4-methylphenyl acrylate (manufactured by SUMILIZER GM, Sumitomo Chemical Co., Ltd.) and 8.62 g of 1,2,2,6,6-pentamethyl-4-piperidyl-methacrylate (LA-82, manufactured by ADEKA Corporation) were added to the dropping funnel, 0.60 g of dimethyl 2,2′-azobis(2-methylpropionate) (V-601, manufactured by FUJIFILM Wako Pure Chemical Corporation) was added as a thermal polymerization initiator, and 20 ml of n-butyl acetate was added to prepare a homogeneous solution. A stopcock of the dropping funnel was opened, and the solution was slowly added dropwise into the flask over 1 hour. Thereafter, the mixture was stirred for 3 hours to perform a polymerization reaction. After the reaction, the flask was removed from the oil bath and cooled sufficiently. Thereafter, 800 ml of ethanol was added to a 1,000 ml beaker and stirred with a magnetic stirrer, into which the solution from the flask after the polymerization reaction was then gradually added dropwise for precipitation. The precipitate was filtered off using suction filtration, and washed and filtered again with ethanol to remove n-butyl acetate and unreacted monomers. The precipitate was dried under reduced pressure to obtain 8.72 g of a light red powder, which was a copolymer of SUMILIZER GM and LA-82. The copolymer of SUMILIZER GM and LA-82 is (meth)acrylate copolymer MA-1.

### Synthesis Example 2: Synthesis of (Meth)Acrylate Copolymer MA-2

8.61 g of a light red powder, which was a copolymer of SUMILIZER GS and LA-82, was obtained in the same manner as in Synthesis Example 1, except that 2.10 g of 2-[1-(2-hydroxy-3,5-di-tert-pentylphenyl)ethyl]-4,6-di-tert-pentylphenyl acrylate (manufactured by SUMILIZER GS, Sumitomo Chemical Co., Ltd.) was used instead of SUMILIZER GM. The copolymer of SUMILIZER GS and LA-82 is (meth)acrylate copolymer MA-2.

### Synthesis Example 3: Synthesis of (Meth)Acrylate Copolymer MA-3

9.75 g of a light red powder, which was a copolymer of SUMILIZER GM, LA-82, and RUVA-93, was obtained in the same manner as in Synthesis Example 1, except that 1.08 g of 2-[2-hydroxy-5-[2-(methacryloyloxy)ethyl]phenyl]-2H-benzotriazole) (manufactured by RUVA-93, Otsuka Chemical Co., Ltd.) was added before providing a thermal polymerization initiator and 0.70 g of V-601 was used as a thermal polymerization initiator. The copolymer of SUMILIZER GM, LA-82, and RUVA-93 is (meth)acrylate copolymer MA-3.

### Synthesis Example 4: Synthesis of (Meth)Acrylate Copolymer MA-4

20.5 g of a white powder, which was a copolymer of SUMILIZER GM, LA-82, RUVA-93, and MMA, was obtained in the same manner as in Synthesis Example 3, except that 11.9 g of methyl methacrylate (MMA, manufactured by Tokyo Chemical Industry Co., Ltd.) was added before providing a thermal polymerization initiator, 0.70 g of V-601 was used as a thermal polymerization initiator, and 40 ml of n-butyl acetate was added to prepared a homogeneous solution. The copolymer of SUMILIZER GM, LA-82, RUVA-93, and MMA is (meth)acrylate copolymer MA-4.

### Synthesis Example 5: Synthesis of (Meth)Acrylate Copolymer MA-5

A white powder (8.83 g), which was a copolymer of LA-82 and RUVA-93, was obtained in the same manner as in Synthesis Example 3, except that SUMILIZER GM was not used and 0.50 g of V-601 was used as a thermal polymerization initiator. The copolymer of LA-82 and RUVA-93 is (meth)acrylate copolymer MA-5.

### Synthesis Example 6: Synthesis of (Meth)Acrylate Copolymer MA-6

To a 100 ml round bottom flask equipped with a condenser, a dropping funnel, a nitrogen inlet tube, and a magnetic stirrer, 25 ml of n-butyl acetate (manufactured by KISHIDA CHEMICAL Co., Ltd.), 20 g of n-butylacrylate (manufactured by Tokyo Chemical Industry Co., Ltd.), 1.0 g of 2-isocyanatoethyl methacrylate (manufactured by Karenz MOI, Resonac Inc.), and 1.0 g of 1-dodecanethiol (manufactured by Tokyo Chemical Industry Co., Ltd.) were added and mixed, and the mixture was stirred at room temperature for 30 minutes under nitrogen bubbling to deoxygenate the solvent. The resulting product was heated in an oil bath up to an internal temperature of about 90° C.

A solution in which 0.005 g of 1,1-di(t-hexylperoxy)cyclohexane (PERHEXA HC, manufactured by NOF CORPORATION) was diluted with 1 g of n-butyl acetate was added to a reaction system via the dropping funnel. This is the initial addition of the polymerization initiator. After one hour, a solution in which 0.007 g of 1,1-di(t-hexylperoxy)-3,3,5-trimethyl cyclohexane was diluted with 1 g of n-butyl acetate, was similarly added to the reaction system. Subsequently, solutions in which 0.010 g, 0.02 g, and 0.07 g of di(3,5,5-trimethylhexanoyl) peroxide (PEROYL 355, manufactured by NOF CORPORATION) was diluted with 1 g of n-butyl acetate were added three times at 1-hour intervals.

7 hours after the initial addition of the polymerization initiator, 0.4 g of pentaerythritol tetrakis(3-(3,5-di-t-butyl-4-hydroxyphenyl) propionate) (Irganox 1010, manufactured by BASF), 0.4 g of 2-(3′,5′-di-t-butyl-2-hydroxyphenyl)-5-chlorobenzotriazole (Tinuvin 327, manufactured by BASF), and 0.4 g of bis(2,2,6,6-tetramethyl-4-piperidyl) sebacate (LA-77, manufactured by ADEKA Corporation) were added and subjected to reaction for an additional 3 hours. After the reaction, the flask was removed from the oil bath and cooled sufficiently. Thereafter, 800 ml of ethanol was added to a 1,000 ml beaker and stirred with a magnetic stirrer, into which the solution from the flask after the polymerization reaction was then gradually added dropwise for precipitation. The precipitate was filtered off using suction filtration, and washed and filtered again with ethanol to remove n-butyl acetate and unreacted monomers. The precipitate was dried under reduced pressure to obtain 20.8 g of a light yellow powder, which was a copolymer of n-butyl acrylate and modified 2-isocyanato ethyl methacrylate. The modified 2-isocyanato ethyl methacrylate is one in which an isocyanate group in 2-isocyanato ethyl methacrylate is modified. The copolymer of n-butyl acrylate and modified 2-isocyanatoethyl methacrylate is (meth)acrylate copolymer MA-6. Synthesis Example 6 follows the method for preparing copolymers disclosed in Examples of patent documents JP 2004-292616 and JP 2005-290269.

(Meth)acrylate copolymer MA-6 may be represented by Formula M6 below. In Formula M6, MY-1 to MY-3 and dashed-line squares are indicated for convenience of description. In Formula M6, O^{a}, O^{b}, and N^{c} represent oxygen atoms or nitrogen atoms, with the alphabets a, b, and c denoted for convenience of description. In Formula M6, m1 is an integer of 1 to 134, m2 is an integer of 1 to 13, m3 is an integer of 1 to 35, and m4 is an integer of 1 to 27.

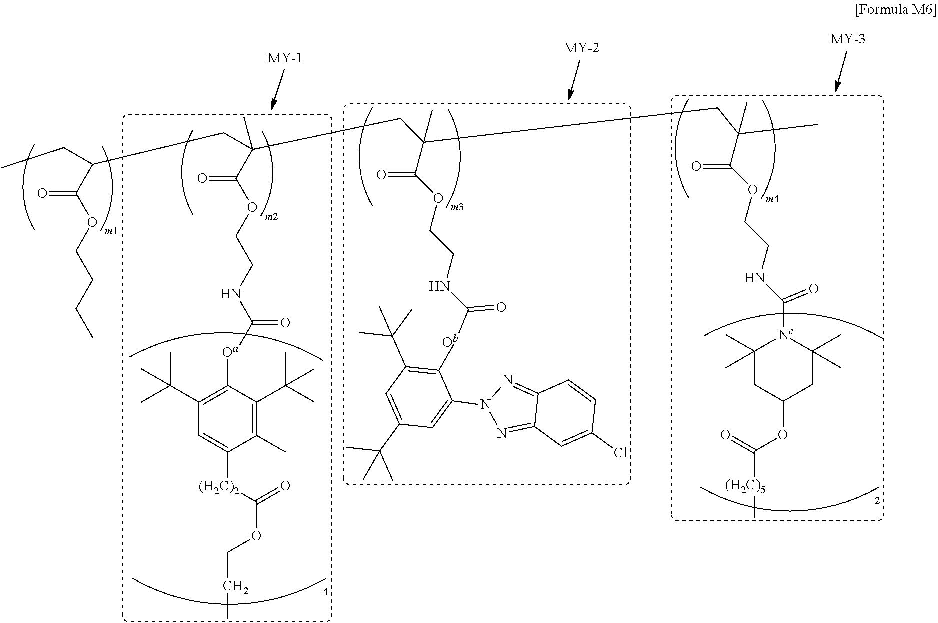

In Formula M6, a first moiety, indicated as MY-1, includes a group in which a reducing functional group (i.e., a hindered phenol group) is modified. The oxygen atom indicated as O^{a} in the first moiety was the oxygen atom of an —OH group forming a hindered phenol group, but was modified into a urethane group. A second moiety, indicated as MY-2, includes a group in which a light-absorbing functional group (i.e., a UV-absorbing functional group) is modified. In the second moiety, the oxygen atom indicated as O^{b} was the oxygen atom of an —OH group forming a hydroxy benzotriazole group, but was modified into a urethane group. A third moiety, indicated as MY-3, includes a group in which a light-stabilizing functional group (i.e., a hindered amine group) is modified. In the third moiety, the nitrogen atom indicated as N^{c} was the nitrogen atom of an —NH group forming a hindered amine group, but was modified into a urea group. In summary, (meth)acrylate copolymer MA-6 is one in which a reducing functional group, an UV-absorbing functional group, and a light-stabilizing functional group are modified, resulting in the loss of reducing, UV-absorbing, and light-stabilizing properties.

Specifically, (meth)acrylate copolymer MA-6 was obtained through primary and secondary reactions. In the primary reaction (radical polymerization reaction), a preliminary (meth)acrylate copolymer including an isocyanate group was obtained, and in the secondary reaction, the isocyanate group reacted with the first to third functional groups. (Meth)acrylate copolymer MA-6 was obtained from the preliminary (meth)acrylate copolymer. The first functional group is the —OH group of a hindered phenol group, which is a reducing functional group. The second functional group is the —OH group of a hydroxy benzotriazole group, which is a UV-absorbing functional group. The third functional group is the —NH group of a hindered amine group, which is a light-stabilizing functional group. In the secondary reaction, the —OH and —NH groups are consumed and modified into a urethane group and a urea group, respectively. At this point, the properties of the reducing functional group, the UV-absorbing functional group, and the light-stabilizing functional group are lost.

### Synthesis Example 7: Synthesis of (Meth)Acrylate Copolymer MA-7

A white powder (6.81 g), which was a copolymer of SUMILIZER GM, RUVA-93, and MMA, was obtained in the same manner as in Synthesis Example 4, except that LA-82 was not used. The copolymer of SUMILIZER GM, RUVA-93, and MMA is (meth)acrylate copolymer MA-7.

Table 1 below shows materials corresponding to the first to third (meth)acrylate monomers used in the synthesis of (meth)acrylate copolymers MA-1 to MA-4, along with amounts thereof.

TABLE 1

| | MA-1 | MA-2 | MA-3 | MA-4 |
|---|---|---|---|---|
| First | SUMILIZER | SUMILIZER | SUMILIZER | SUMILIZER |
| (meth)acrylate | GM, | GS, | GM, | GM, |
| monomer | 2.1 g | 2.1 g | 2.1 g | 2.1 g |
| Second | LA-82, | LA-82, | LA-82, | LA-82, |
| (meth)acrylate | 8.62 g | 8.62 g | 8.62 g | 8.62 g |
| monomer | | | | |
| Third | — | — | RUVA-93, | RUVA-93, |
| (meth)acrylate | | | 1.08 g | 1.08 g |
| monomer | — | — | — | MMA, |
| | | | | 11.9 g |

Referring to Table 1, when a total weight of the first and second (meth)acrylate monomers provided in the synthesis of (meth)acrylate copolymer MA-1 is set to 100 parts by weight, the first (meth)acrylate monomer is provided in an amount of about 19.5 parts by weight.

When a total weight of the first and second (meth)acrylate monomers provided in the synthesis of (meth)acrylate copolymer MA-2 is set to 100 parts by weight, the first (meth)acrylate monomer is provided in an amount of about 19.5 parts by weight. When a total weight of the first to third (meth)acrylate monomers provided in the synthesis of (meth)acrylate copolymer MA-3 is set to 100 parts by weight, the first (meth)acrylate monomer is provided in an amount of about 17.8 parts by weight. When a total weight of the first to third (meth)acrylate monomers provided in the synthesis of (meth)acrylate copolymer MA-4 is set to 100 parts by weight, the first (meth)acrylate monomer is provided in an amount of about 8.9 parts by weight.

In an aspect, with respect to 100 parts by weight of a total weight of the (meth)acrylate monomers provided in the radical polymerization reaction for forming a (meth)acrylate copolymer, the first (meth)acrylate monomer including a hindered phenol group may be provided in an amount of about 0.01 parts by weight to about 20 parts by weight. As discussed above, it is seen that the parts by weight of the first (meth)acrylate monomer provided during the polymerization reaction for forming (meth)acrylate copolymers MA-1 to MA-4 satisfy the range of parts by weight according to an aspect.

### 2. Preparation of Resin Composition

Materials listed in Tables 2 and 3 below were placed in a light-shielding sealed container according to mixing ratios (unit: parts by weight) and stirred at room temperature for 12 hours using a mixer rotor. The mixture was confirmed to be uniform and used as the resin composition for Examples and Comparative Examples.

### <Data on Materials in Tables 2 and 3>

### [Monofunctional (Meth)Acrylate Monomer]

4-HBA: 4-hydroxybutyl acrylate (manufactured by Osaka Organic Chemical Industry Co., Ltd.)
THFA: Tetrahydrofurfuryl acrylate (manufactured by Kyoeisha Chemical Co., Ltd.)
2-EHA: 2-ethylhexyl acrylate (manufactured by Toagosei Co., Ltd.)

### [Photoradical Polymerization Initiator]

Omnirad 819: phenyl bis(2,4,6-trimethylbenzoyl)-phosphine oxide (manufactured by IGM Resins)

### [Hindered Phenol Additive]

AO-50: ((octadecyl 3-(3,5-di-tert-butyl-4-hydroxyphenyl) propionate) (manufactured by ADEKA Corporation)

### [Hindered Amine Additive]

LA-72: (bis(1,2,2,6,6-pentamethyl-4-piperidyl) sebacate) (manufactured by ADEKA Corporation)

### [UV Absorber]

Tinuvin 928: (2-(2H-benzotriazol-2-yl)-6-(1-methyl-1-phenylethyl)-4-(1,1,3,3-tetramethylbutyl) phenol) (manufactured by BASF)

TABLE 2

| | | Exam- | Exam- | Exam- | Exam- |
|---|---|---|---|---|---|
| | | ple 1 | ple 2 | ple 3 | ple 4 |
| (Meth)acrylate | MA-1 | 10 | | | |
| copolymer | MA-2 | | 10 | | |
| | MA-3 | | | 10 | |
| | MA-4 | | | | 10 |
| Monofunctional | 4-HBA | 5.0 | 5.0 | 5.0 | 5.0 |
| (meth)acrylate | THFA | 24 | 24 | 24 | 24 |
| monomer | 2-EHA | 60 | 60 | 60 | 60 |
| Photoradical | Omnirad | 1.0 | 1.0 | 1.0 | 1.0 |
| polymerization | 819 | | | | |
| initiator | | | | | |

Referring to Table 2, the resin compositions of Examples 1 to 4 are resin compositions according to an aspect, each including (meth)acrylate copolymers MA-1 to MA-4. In addition, the resin compositions of Examples 1 to 4 include 4-HBA, THFA, and 2-EHA as monofunctional (meth)acrylate monomers, and Omnirad 819 as a photoradical polymerization initiator.

(Meth)acrylate copolymers MA-1 to MA-4 are (meth)acrylate copolymers according to an aspect, each including a hindered phenol group and a hindered amine group. (Meth)acrylate copolymers MA-3 and MA-4 are synthesized using RUVA-93 and further include UV-absorbing functional groups. (Meth)acrylate copolymer MA-4 is synthesized using MMA and further includes a hydrocarbon structure derived from MMA. Accordingly, (meth)acrylate copolymer MA-4 exhibits improved plasticity, and the resin composition of Example 4 including (meth)acrylate copolymer MA-4 exhibits improved adhesive strength after curing.

TABLE 3

| | | Comparative | Comparative | Comparative | Comparative | Comparative | Comparative |
|---|---|---|---|---|---|---|---|
| | | Example | Example | Example | Example | Example | Example |
| | | 1 | 2 | 3 | 4 | 5 | 6 |
| (meth)acrylate | MA-5 | | | | 10 | | |
| copolymer | MA-6 | | | | | 10 | |
| | MA-7 | | | | | | 10 |
| Monofunctional | 4-HBA | 5.0 | 5.0 | 5.0 | 5.0 | 5.0 | 5.0 |
| (meth)acrylate | THFA | 24 | 24 | 24 | 24 | 24 | 24 |
| monomer | 2-EHA | 60 | 60 | 60 | 60 | 60 | 60 |
| Photoradical | Omnirad | 1.0 | 1.0 | 1.0 | 1.0 | 1.0 | 1.0 |
| polymerization | 819 | | | | | | |
| initiator | | | | | | | |
| Hindered | AO-50 | | 1.0 | 1.0 | | | |
| phenol additive | | | | | | | |
| Hindered | LA-72 | | 1.0 | 1.0 | | | |
| amine additive | | | | | | | |
| UV absorber | Tinuvin | | | 0.1 | | | |
| | 928 | | | | | | |

Referring to Table 2, the resin compositions of Comparative Examples 1 to 3 do not include a (meth)acrylate copolymer. The resin compositions of Comparative Examples 2 and 3 include hindered phenol additives and hindered amine additives, which differs from (meth)acrylate copolymers MA-1 to MA-4 included in the resin compositions of Examples 1 to 4. (Meth)acrylate copolymers MA-1 to MA-4 include both hindered phenol groups and hindered amine groups within the copolymers. The resin composition of Comparative Example 3 includes a UV absorber, which differs from (meth)acrylate copolymers MA-3 and MA-4 including UV-absorbing functional groups within the copolymers.

The resin compositions of Comparative Examples 4 to 6 each include (meth)acrylate copolymers MA-5 to MA-7, which are the copolymers of Comparative Examples. (Meth)acrylate copolymer MA-5 is a copolymer formed without providing a (meth)acrylate monomer including a hindered phenol group. (Meth)acrylate copolymer MA-6 is a copolymer in which the hindered phenol group and the hindered amine group are modified into a urethane group and a urea group, respectively, as described above with reference to Formula M6. (Meth)acrylate copolymer MA-7 is a copolymer formed without providing a (meth)acrylate monomer including a hindered amine group.

### 3. Evaluation of Adhesive Member

Table 4 below shows the evaluation of adhesive members of Examples and Comparative Examples formed from the resin compositions of Examples and Comparative Examples. In Table 4 below, Examples E-1 to E-4 are adhesive members formed using the resin compositions of Examples 1 to 4, respectively. Comparative Examples C-1 to C-6 are adhesive members formed using the resin compositions of Comparative Examples 1 to 6, respectively. The 180° peel strength and yellow index of the adhesive members were evaluated using the following methods, using laminates manufactured according to the following bonding process as test specimens.

### <Bonding Process>

A resin composition was applied onto a first substrate, and the applied resin composition was irradiated with ultraviolet rays in an atmosphere to form an adhesive member. Thereafter, a second substrate was bonded to one surface of the adhesive member, thereby obtaining a laminate including the first substrate, the adhesive member, and the second substrate. The irradiation with ultraviolet rays was performed using a 365 nm UV-LED lamp up to a total light dose of 1000 mJ/cm².

### <180° Peel Strength of Adhesive Member>

According to the bonding process, a resin composition was applied to a thickness of 100 μm on one surface of a 76 mm×26 mm slide glass and cured through the irradiation with ultraviolet rays in the atmosphere. A PET film having a size of 150 mm×20 mm and a thickness of 50 μm was then bonded to the resulting product using an atmospheric pressure laminator to create a lamination structure, which was then degassed under pressure in an autoclave at 30° C. and 0.5 MPa for 5 minutes. The resulting laminate was used as a test specimen for evaluating 180° peel strength. The 180° peel strength was evaluated at 25° C. in accordance with JIS Z0237. Values obtained by applying average values of the peel strength in a range of 20 to 80 mm from the initiation of peeling are recorded in Table 4, as shown below. A 180° peel strength of 1500 gf/25 mm or greater was recorded as ‘O’, and a 180° peel strength of less than 1500 gf/25 mm was recorded as ‘X’.

### <Yellow Index of Adhesive Member>

The yellow index of the adhesive member was evaluated in accordance with MIL-STD-810G.

According to the bonding process, a resin composition was applied to a thickness of 100 μm on one surface of a 76 mm×26 mm slide glass and cured through the irradiation with ultraviolet rays in the atmosphere. Slide glasses of the same size was then bonded to the resulting product using an atmospheric pressure laminator to create a lamination structure, which was then degassed under pressure in an autoclave at 30° C. and 0.5 MPa for 5 minutes. The resulting laminate was used as a test specimen for evaluating yellow index. Yellow index was measured after a weather resistance test.

Using a Q-SUN Xe-1 desktop xenon accelerated weather resistance tester from Q-LAB, the test specimens were exposed for 200 hours under conditions of 0.4 mW and 60° C. After completion, the yellow index (YI) of the test specimens was measured using a COH7700 spectrophotometer (manufactured by Nippon Denshoku Kogyo Co., Ltd.) to evaluate yellowing. A smaller absolute value of YI indicates less yellowing and better weather resistance. The obtained YI was recorded in Table 4 as follows. A YI of 0.50 or less was recorded as ‘O’, and a YI of greater than 0.50 was recorded as ‘X’.

TABLE 4

| | Example | Example | Example | Example |
|---|---|---|---|---|
| | E-1 | E-2 | E-3 | E-4 |
| 180° peel | 2300 | 2200 | 2700 | 3000 |
| strength | ◯ | ◯ | ◯ | ◯ |
| [gf/25 mm, | | | | |
| 25° C.] | | | | |
| Yellow Index | 0.48◯ | 0.47 | 0.40 | 0.39 |
| (YI) | | ◯ | ◯ | ◯ |

| | Comparative | Comparative | Comparative | Comparative | Comparative | Comparative |
|---|---|---|---|---|---|---|
| | Example | Example | Example | Example | Example | Example |
| | C-1 | C-2 | C-3 | C-4 | C-5 | C-6 |
| 180° peel | 80 | 200 | 150 | 2200 | 800 | 2000 |
| strength | X | X | X | ◯ | X | ◯ |
| [gf/25 mm, | | | | | | |
| 25° C.] | | | | | | |
| Yellow Index | 2.17 | 1.23 | 0.72 | 0.55 | 1.36 | 1.47 |
| (YI) | X | X | X | X | X | X |

Referring to Table 4, it is seen that the adhesive members of Examples E-1 to E-4 have a 180° peel strength of 1500 gf/25 mm or greater at a temperature of about 25° C. It is seen that the adhesive members of Examples E-1 to E-4 have a yellow index of 0.5 or less after a weather resistance test. The adhesive members of Examples E-1 to E-4 are each formed from the resin compositions of Examples 1 to 4, and the resin compositions of Examples 1 to 4 each include (meth)acrylate copolymers MA-1 to MA-4. (Meth)acrylate copolymers MA-1 to MA-4 each include a hindered phenol group and a hindered amine group, and is formed through a radical polymerization reaction of a first (meth)acrylate monomer including a hindered phenol group and a second (meth)acrylate monomer including a hindered amine group. Accordingly, it is seen that a resin composition including (meth)acrylate derived from a radical polymerization reaction of a first (meth)acrylate monomer including a hindered phenol group and a second (meth)acrylate monomer including a hindered amine group in an aspect may exhibit excellent adhesive reliability and excellent weather resistance after curing.

The adhesive member of Comparative Example C-1 was formed from the resin composition of Comparative Example 1, which does not contain a (meth)acrylate copolymer. The adhesive member of Comparative Example C-1 has a 180° peel strength of 80 gf/25 mm at 25° C., which is less than 1500 gf/25 mm. A 180° peel strength of 80 gf/25 mm indicates virtually no adhesive strength. After a weather resistance test, the adhesive member of Comparative Example C-1 has a yellow index of 2.17, which is greater than 0.5. Due to inhibition of the reaction on an outermost surface caused by oxygen during curing in the atmosphere, the adhesive member of Comparative Example C-1 exhibited strong yellowing.

The adhesive members of Comparative Examples C-2 and C-3 are formed from the resin compositions of Comparative Examples 2 and 3, respectively, and the resin compositions of Comparative Examples 2 and 3 does not include a (meth)acrylate copolymer. The adhesive member of Comparative Example C-2 has a 180° peel strength of 200 gf/25 mm at a temperature of about 25° C., which is a 180° peel strength of less than 1500 gf/25 mm. After a weather resistance test, the adhesive member of Comparative Example C-2 has a yellow index of 1.23, which is a yellow index of greater than 0.50. The adhesive member of Comparative Example C-3 has a 180° peel strength of 150 gf/25 mm at a temperature of about 25° C., which is a 180° peel strength of less than 1500 gf/25 mm. After a weather resistance test, the adhesive member of Comparative Example C-3 has a yellow index of 0.72, which is a yellow index of greater than 0.50

The resin composition of Comparative Example 2 includes a hindered phenol additive and a hindered amine additive, and the resin composition of Comparative Example 3 includes a hindered phenol additive, a hindered amine additive, and a UV absorber. The additives and UV absorbers do not exhibit surface segregation effects, and accordingly, the adhesive members of Comparative Examples C-2 and C-3, formed from the resin compositions of Comparative Examples 2 and 3, exhibits low adhesive strength and low weather resistance.

The adhesive member of Comparative Example C-4 is formed from the resin composition of Comparative Example 4, which includes (meth)acrylate copolymer MA-5. After a weather resistance test, the adhesive member of Comparative Example C-4 has a yellow index of 0.55, which is a yellow index of greater than 0.50 (Meth)acrylate copolymer MA-5 includes a hindered amine group and a UV-absorbing functional group, but does not include a hindered phenol group. Accordingly, the adhesive member of Comparative Example C-4 exhibits low weather resistance after a weather resistance test.

The adhesive member of Comparative Example C-5 is formed from the resin composition of Comparative Example 5, which includes (meth)acrylate copolymer MA-6. The adhesive of Comparative Example C-5 has a 180° peel strength of 800 gf/25 mm at 25° C., which is a 180° peel strength of less than 1,500 gf/25 mm. After a weather resistance test, the adhesive member of Comparative Example C-5 has a yellow index of 1.36, which is a yellow index of greater than 0.50. The reasons for this low adhesive strength and low weather resistance include the fact that (meth)acrylate copolymer MA-6 has a structure close to a three-dimensional crosslink, that the cohesion of the outermost surface of the adhesive member is excessively high, and that the hindered phenol group, the hindered amine group, and the UV-absorbing functional group are modified, as previously described with reference to Formula M6.

The adhesive member of Comparative Example C-6 is formed from the resin composition of Comparative Example 6, which includes (meth)acrylate copolymer MA-7. After a weather resistance test, the adhesive member of Comparative Example C-6 has a yellow index of 1.47, which is a yellow index of greater than 0.50. The (meth)acrylate copolymer MA-7 includes a hindered phenol group and a UV-absorbing functional group, but does not include a hindered amine group. Accordingly, the adhesive member of Comparative Example C-6 exhibits low weather resistance after a weather resistance test.

An electronic apparatus according to an aspect may include an adhesive member according to an aspect between a display panel and a window. The electronic apparatus according to an aspect may be manufactured using a method for manufacturing an electronic apparatus according to an aspect. An electronic apparatus according to an aspect may include providing a resin composition to form an adhesive member. The resin composition may include a (meth)acrylate copolymer derived from a radical polymerization reaction of a first (meth)acrylate monomer including a hindered phenol group and a second (meth)acrylate monomer including a hindered amine group. The (meth)acrylate copolymer may include a hindered phenol group and a hindered amine group. Accordingly, the resin composition according to an aspect may exhibit excellent processability when photocured in an atmosphere, and may exhibit excellent adhesive strength and excellent weather resistance after curing. The electronic apparatus according to an aspect including the adhesive member formed by curing the resin composition may exhibit excellent reliability.

A resin composition according to an aspect includes a (meth)acrylate copolymer derived from a radical polymerization reaction of a first (meth)acrylate monomer including a hindered phenol group and a second (meth)acrylate monomer including a hindered amine group, and may thus exhibit excellent processability upon curing and excellent adhesive strength and excellent weather resistance after curing.

A method for manufacturing an electronic apparatus according to an aspect includes providing a resin composition according to an aspect to form an adhesive member, and may thus exhibit excellent processability.

An electronic apparatus according to an aspect includes an adhesive member including a polymer derived from a resin composition according to an aspect, and may thus exhibit excellent reliability.

In the above, description has been made with reference to aspects of the present disclosure, but those skilled or of ordinary skill in the art may understand that various modifications and changes may be made to aspects of the present disclosure insofar as such modifications and changes do not depart from the spirit and technical scope of the present disclosure set forth in the claims to be described later.

Therefore, the technical scope of the present disclosure is not to be limited to the contents stated in the detailed description of the specification, but should be determined by the claims.

What is claimed is:

1. A resin composition comprising a (meth)acrylate copolymer derived from a radical polymerization reaction of a first (meth)acrylate monomer including a hindered phenol group and a second (meth)acrylate monomer including a hindered amine group.

2. The resin composition of claim 1, wherein the (meth)acrylate copolymer is represented by Formula 1: 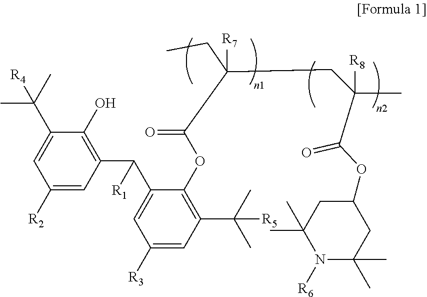
wherein in Formula 1,
R₁ is a hydrogen atom or an alkyl group having 1 to 10 carbon atoms,
R₂ to R₅ are each independently an alkyl group having 1 to 10 carbon atoms,
R₆ is a hydrogen atom, an alkyl group having 1 to 10 carbon atoms, or an alkoxy group having 1 to 12 carbon atoms,
R₇ and R₈ are each independently a hydrogen atom or a methyl group,
n1 is an integer of 1 to 24, and
n2 is an integer of 12 to 200.

3. The resin composition of claim 1, wherein the first (meth)acrylate monomer comprises a first moiety represented by Formula M-1, and the second (meth)acrylate monomer comprises a second moiety represented by Formula M-2: 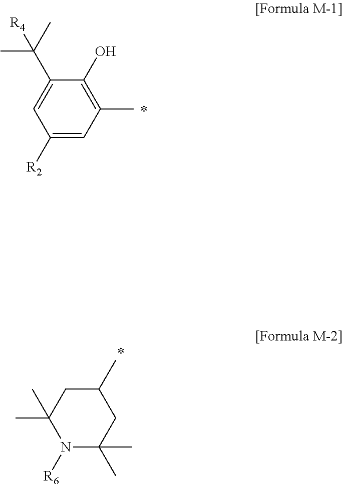
wherein in Formula M-1,
R₂ and R₄ are each independently an alkyl group having 1 to 10 carbon atoms, and
wherein in Formula M-2,
R₆ is a hydrogen atom, an alkyl group having 1 to 10 carbon atoms, or an alkoxy group having 1 to 12 carbon atoms.

4. The resin composition of claim 1, wherein the first (meth)acrylate monomer is provided in an amount of about 0.01 parts by weight to about 20 parts by weight with respect to 100 parts by weight of a total weight of the (meth)acrylate monomers provided in the radical polymerization reaction.

5. The resin composition of claim 1, wherein the radical polymerization reaction further includes a third (meth)acrylate monomer that does not include the hindered phenol group and the hindered amine group.

6. The resin composition of claim 5, wherein the third (meth)acrylate monomer comprises a functional group that absorbs ultraviolet rays.

7. The resin composition of claim 5, wherein the third (meth)acrylate comprises at least one of 2-[2-hydroxy-5-[2-monomer (methacryloyloxy)ethyl]phenyl]-2H-benzotriazole or methyl methacrylate (MMA).

8. The resin composition of claim 1, further comprising at least one monofunctional (meth)acrylate monomer and at least one photoradical polymerization initiator,
wherein the monofunctional (meth)acrylate monomer includes at least one of 4-hydroxybutyl acrylate (4-HBA), 2-ethylhexyl acrylate (2-EHA), or tetrahydrofurfuryl acrylate (THFA).

9. The resin composition of claim 1, wherein the resin composition has a 180° peel strength of about 1500 gf/25 mm or greater against at least one of a glass substrate or a polymer substrate at a temperature of about 25° C. after atmospheric curing.

10. A method for manufacturing an electronic apparatus, the method comprising:
preparing a display panel;
seating a window on the display panel; and
applying an adhesive member to the display panel or the window before the seating of the window on the display panel, such that the adhesive member is between the window and the display panel;
wherein the applying of the adhesive member includes:
depositing a resin composition including a (meth)acrylate copolymer on the display panel or the window; and
irradiating the resin composition with light under atmospheric conditions to form the adhesive member, and
wherein the (meth)acrylate copolymer is derived from a radical polymerization reaction of a first (meth)acrylate monomer including a hindered phenol group and a second (meth)acrylate monomer including a hindered amine group.

11. The method of claim 10, wherein the (meth)acrylate copolymer is represented by Formula 1: 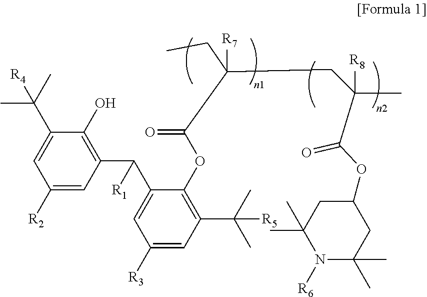
wherein in Formula 1,
R₁ is a hydrogen atom or an alkyl group having 1 to 10 carbon atoms,
R₂ to R₅ are each independently an alkyl group having 1 to 10 carbon atoms,
R₆ is a hydrogen atom, an alkyl group having 1 to 10 carbon atoms, or an alkoxy group having 1 to 12 carbon atoms,
R₇ and R₈ are each independently a hydrogen atom or a methyl group,
n1 is an integer of 1 to 24, and
n2 is an integer of 12 to 200.

12. The method of claim 10, wherein the first (meth)acrylate monomer comprises a first moiety represented by Formula M-1, and the second (meth)acrylate monomer comprises a second moiety represented by Formula M-2: 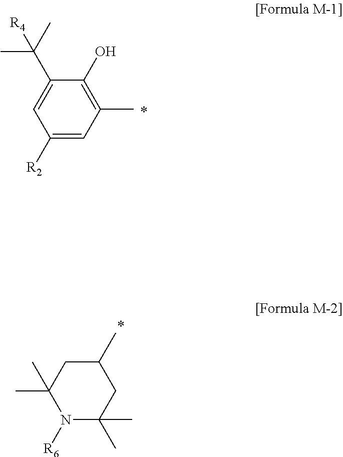
wherein in Formula M-1,
R₂ and R₄ are each independently an alkyl group having 1 to 10 carbon atoms, and
wherein in Formula M-2,
R₆ is a hydrogen atom, an alkyl group having 1 to 10 carbon atoms, or an alkoxy group having 1 to 12 carbon atoms.

13. The method of claim 10, wherein the first (meth)acrylate monomer is provided in an amount of about 0.01 parts by weight to about 20 parts by weight with respect to 100 parts by weight of a total weight of the (meth)acrylate monomers provided in the radical polymerization reaction.

14. The method of claim 10, wherein the radical polymerization reaction further includes a third (meth)acrylate monomer that does not include the hindered phenol group and the hindered amine group.

15. The method of claim 10, the resin composition further comprises at least one monofunctional (meth)acrylate monomer and at least one photoradical polymerization initiator.

16. The method of claim 10, wherein the resin composition is deposited through inkjet printing or dispensing.

17. An electronic apparatus comprising:
a display panel;
a window seated on the display panel; and
an adhesive member between the display panel and the window, wherein the adhesive member comprises a polymer derived from a resin composition,
wherein the resin composition includes a (meth)acrylate copolymer derived from a radical polymerization reaction of a first (meth)acrylate monomer including a hindered phenol group and a second (meth)acrylate monomer including a hindered amine group.

18. The electronic apparatus of claim 17, wherein the adhesive member has a 180° peel strength of about 1500 gf/25 mm or greater against at least one of a glass substrate or a polymer substrate at a temperature of about 25° C.

19. The electronic apparatus of claim 17, further comprising a light control layer between the adhesive member and the window, and an optical adhesive layer between the light control layer and the window,
wherein the optical adhesive layer includes a polymer derived from the resin composition.

20. The electronic apparatus of claim 17, further comprising an input sensing portion between the display panel and the window,
wherein the adhesive member is between the display panel and the input sensing portion or the adhesive member is between the input sensing portion and the window.
